(19) United States
(12) Patent Application Publication
(10) Pub. No.: US 2021/0402673 A1
(43) Pub. Date: Dec. 30, 2021

(54) APPARATUS AND METHOD FOR BENDING AN OBJECT

(71) Applicant: 3M INNOVATIVE PROPERTIES COMPANY, St. Paul, MN (US)

(72) Inventors: Thomas R. Corrigan, St. Paul, MN (US); Hollis Z. Beagi, Stillwater, MN (US)

(21) Appl. No.: 17/281,316

(22) PCT Filed: Oct. 19, 2019
(86) PCT No.: PCT/IB2019/058824

§ 371 Date: Mar. 30, 2021

Related U.S. Application Data
(60) Provisional application No. 62/751,309, filed on Oct. 26, 2018.

(51) Int. Cl. B29C 53/04

(52) U.S. Cl. CPC B29C 53/04

(57) ABSTRACT

An apparatus for bending an object includes a first bending plate having a first rotational axis, and a second bending plate having a second rotational axis. The second bending plate is disposed proximate to the first bending plate. The apparatus further includes a pair of rotation elements. Each rotation element controls a respective bending plate from the first bending plate and the second bending plate. The first bending plate and the second bending plate are configured to rotate independently from each other about the first rotational axis and the second rotational axis, respectively.

### TECHNICAL FIELD

The present disclosure relates to an apparatus and a method for bending an object.

### BACKGROUND

Conventional testing units for bending samples typically include a stationary component that secures one end of the sample and a movable component that moves another end of the sample. The movement may be linear or rotational. Such a bending configuration may cause undesirable bending stress and resultant strain in the sample. Further, conventional testing units may not be adjustable as per application requirements.

### SUMMARY

In one aspect, the present disclosure provides an apparatus for bending an object. The apparatus includes a first bending plate having a first rotational axis, and a second bending plate having a second rotational axis. The second bending plate is disposed proximate to the first bending plate. The apparatus further includes a pair of rotation elements. Each rotation element controls a respective bending plate from the first bending plate and the second bending plate. The first bending plate and the second bending plate are configured to rotate independently from each other about the first rotational axis and the second rotational axis, respectively.

In another aspect, the present disclosure provides a method for bending an object. The method includes providing a first bending plate having a first rotational axis, and providing a second bending plate having a second rotational axis. The second bending plate is disposed proximate to the first bending plate. The method further includes removably mounting the object on the first bending plate and the second bending plate. The method further includes providing a pair of rotation elements. Each rotation element is configured to selectively rotate a respective bending plate from the first bending plate and the second bending plate. The method further includes controlling, via a controller, the pair of rotation elements to rotate the first bending plate and the second bending plate independently from each other about the first rotational axis and the second rotational axis, respectively.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a perspective view of an apparatus for bending an object according to one embodiment of the present disclosure;

FIG. 2 is a perspective view of the apparatus of FIG. 1 in an intermediate configuration;

FIG. 3 is a perspective view of the apparatus of FIG. 1 in a raised configuration;

FIG. 4 is an exploded view of a bending unit of the apparatus according to one embodiment of the present disclosure;

FIG. 5 is a perspective view of the bending unit of FIG. 4 in an assembled state;

FIG. 6 is a perspective view of the apparatus showing assembly of the bending units according to one embodiment of the present disclosure;

FIG. 7 is a top view of a bending system according to one embodiment of the present disclosure;

FIG. 8 is a block diagram of a control system of the apparatus according to one embodiment of the present disclosure;

FIG. 9 is a top view of a user interface of the apparatus according to one embodiment of the present disclosure;

FIG. 10 is a top view of the apparatus of FIG. 1 in a raised configuration;

FIGS. 11A and 11B illustrate schematic views of the apparatus in different configurations according to one embodiment of the present disclosure;

FIG. 12 is a perspective view of the apparatus showing adjustment using gauge blocks according to one embodiment of the present disclosure;

FIG. 13 is a detailed perspective view of the apparatus showing access apertures according to one embodiment of the present disclosure;

FIG. 14 is a detailed side view of the apparatus showing adjustment using gauge blocks according to one embodiment of the present disclosure;

FIG. 15 is a perspective view of the apparatus showing adjustment using a single gauge block according to one embodiment of the present disclosure;

FIG. 16 is a detailed perspective view of the apparatus according to one embodiment of the present disclosure;

FIGS. 17A-17C illustrate schematic views of the apparatus in different configurations with an object undergoing bending according to one embodiment of the present disclosure;

FIG. 18 is a perspective view of a safety cage in an disassembled state according to one embodiment of the present disclosure;

FIG. 19 is a perspective view of the safety cage in an assembled state according to one embodiment of the present disclosure;

FIG. 20 is a detailed perspective view of an interlock mechanism of the safety cage according to one embodiment of the present disclosure;

FIG. 21 is a schematic view of an interlock control system according to one embodiment of the present disclosure;

FIG. 22 is a perspective view of an apparatus for bending an object according to another embodiment of the present disclosure;

FIGS. 23A-23D are schematic views of the apparatus in different configurations according to another embodiment of the present disclosure;

FIG. 24 is a schematic view of the apparatus with an object undergoing bending according to another embodiment of the present disclosure; and

FIG. 25 is a flowchart of a method for bending an object according to one embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

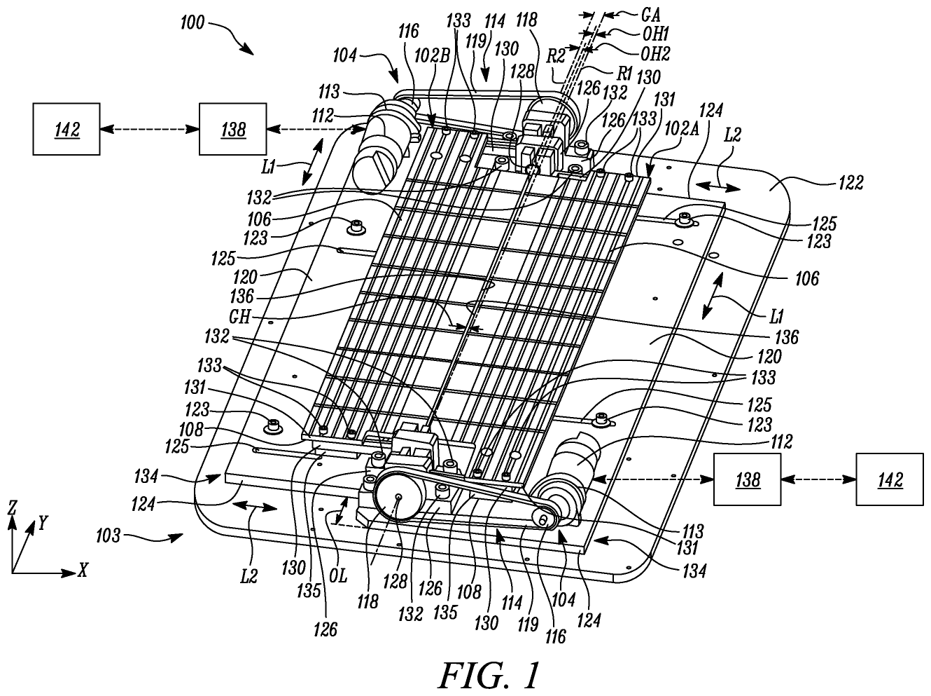

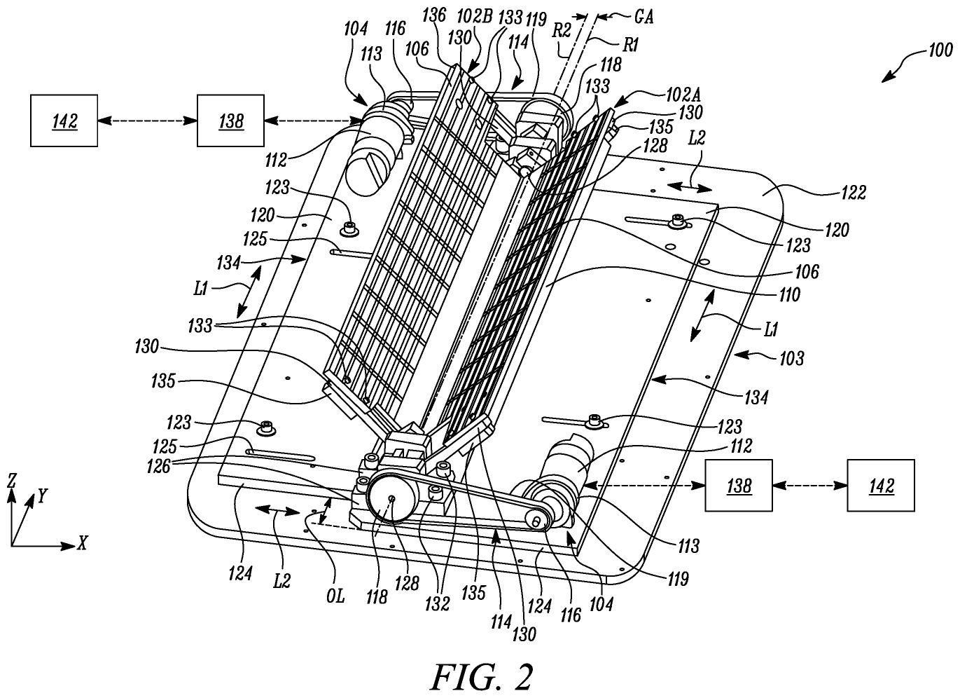

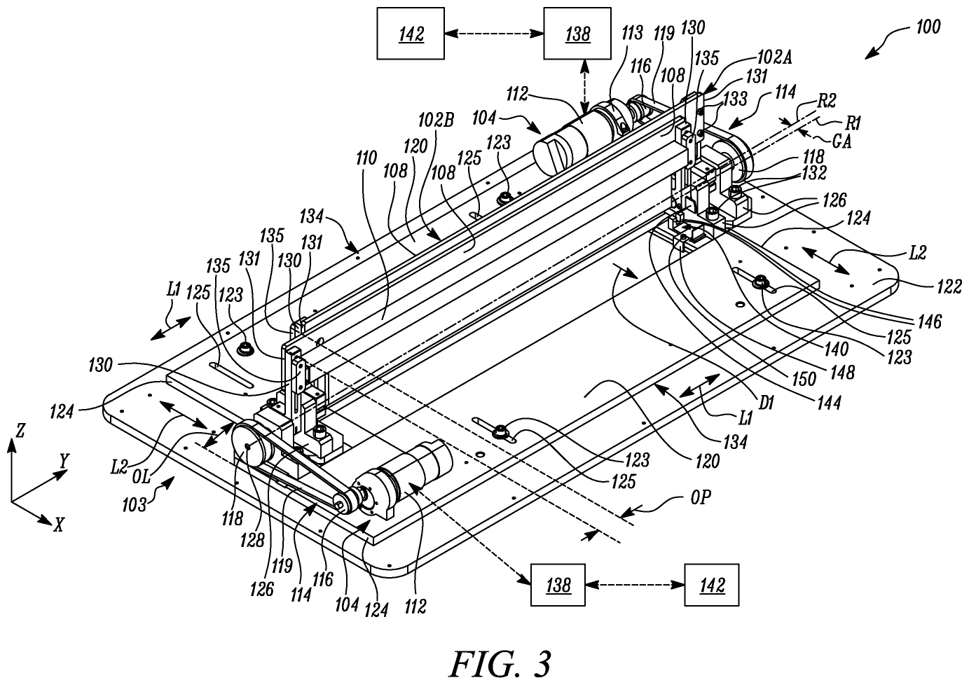

Referring now to the Figures, FIG. 1 illustrates an apparatus 100 for bending an object according to an embodiment of the present disclosure. In some embodiments, the object that undergoes bending is a flexible display component. The flexible display component may include a component for a flexible display. The flexible display may be a flexible organic light-emitting diode (OLED) display. Further, the flexible display component may include various components, for example, a foldable optically clear adhesive (OCA), a barrier film to protect OLED components, a flexible cover window film that provides protection, durability, touch and clean functionalities, and a backside adhesive component for flexible displays. The object undergoing bending may also be a flexible display panel. The apparatus 100 may be used to repeatedly bend samples of various materials over a large number of bending cycles. The apparatus 100 may test the sample or component in an expected mode of operation in an accurate and reliable manner. Further, the apparatus 100 defines an X-axis along a length of the apparatus 100, a Y-axis along a width of the apparatus 100, and a Z-axis along a height of the apparatus 100. FIGS. 2 and 3 illustrate other views of the apparatus 100.

Referring to FIGS. 1-3, the apparatus 100 includes a first bending plate 102A, a second bending plate 102B disposed proximate to the first bending plate 102A, a support structure 103 for rotatably supporting the first bending plate 102A and the second bending plate 102B, and a pair of rotation elements 104. Each rotation element 104 controls a respective bending plate 102A or 102B from the first bending plate 102A and the second bending plate 102B. Each of the pair of rotation elements 104 is operably coupled to the respective bending plate 102A or 102B. The first and second bending plates 102A, 102B may be collectively referred to as the “bending plates 102” or “the bending plate 102”.

The first bending plate 102A has a first rotational axis “R1”. Specifically, the first bending plate 102A is rotatable about the first rotational axis “R1”. Similarly, the second bending plate 102B has a second rotational axis “R2”. Specifically, the second bending plate 102B is rotatable about the second rotational axis “R2”. The first bending plate 102A and the second bending plate 102B are configured to rotate independently from each other about the first rotational axis “R1” and the second rotational axis “R2”, respectively. Each of the pair of rotation elements 104 may control the rotation of the respective bending plate 102A or 102B about the respective rotational axis “R1” or “R2”.

In some embodiments, each of the first and second bending plates 102A, 102B has a generally planar shape and includes a front surface 106 and a rear surface 108 (shown in FIG. 3) opposite to the front surface 106. Although each of the first and second bending plates 102A, 102B is illustrated as having a generally planar shape, in other embodiments, each of the first and second bending plates 102A, 102B may have a curved shape based on bending requirements. The front surface 106 supports the object that undergoes bending. The object may be removably mounted on the first bending plate 102A and the second bending plate 102B. Specifically, the object may be removably mounted on the front surface 106 of each of the first and second bending plates 102A, 102B. For example, the object may be mounted on the front surface 106 by an adhesive tape. In some cases, each of the first and second bending plates 102A, 102B may be made of a metallic material, for example, black anodized aluminum. In the illustrated embodiment, the front surface 106 includes an etched grid pattern that is formed post anodizing. The grid pattern may facilitate mounting and supporting of the object without slipping. In some cases, one or more corners of each of the first and second bending plates 102A, 102B may be rounded or chamfered to prevent sharp edges. Each of the first and second bending plates 102A, 102B includes a stiffening member 110 (shown in FIG. 3) extending at least partly across a length of the respective bending plate 102A or 102B. In some cases, the stiffening member 110 may have a generally hollow rectangular cross-section. In some other cases, the stiffening member 110 may provide structural strength and rigidity to the respective bending plate 102. The stiffening member 110 may be disposed on the rear surface 108 of the respective bending plate 102. In some cases, the stiffening member 110 may be coupled to the respective bending plate 102 by various methods, for example, but not limited to, adhesive bonding (e.g., through an epoxy-based adhesive), mechanical fasteners, welding, and so forth.

Each rotation element 104 is configured to selectively rotate the respective bending plate 102A or 102B from the first bending plate 102A and the second bending plate 102B. Each of the rotation elements 104 further includes an electric motor 112 operably coupled to the respective bending plate 102A or 102B. In some cases, the electric motor 112 may be an alternating current (AC) motor or a direct current (DC) motor. In an example, the electric motor 112 may be a 12 volt (V) gearmotor manufactured by NeveRest. In some cases, the electric motor 112 may have an integral gearbox with a 60:1 reduction ratio. In some other cases, an output shaft (not shown in FIGS. 1-3) of the electric motor 112 is connected to the gearbox. In some cases, the electric motor 112 may include a hall effect encoder. In some other cases, the encoder may have 1680 pulses per revolution (ppr). In some cases, each of the electric motors 112 may be a servo-controlled motor.

Each of the rotation elements 104 further includes a belt and pulley assembly 114 configured to operably couple the electric motor 112 to the respective bending plate 102A or 102B. The belt and pulley assembly 114 includes a motor pulley 116 driven by the output shaft of the electric motor 112, a plate pulley 118 driving the respective bending plate 102, and a belt 119 wrapped around the motor pulley 116 and the plate pulley 118.

The rotation elements 104, as shown in FIGS. 1 to 3, are exemplary in nature, and various alternative configurations of the rotation elements 104 may be possible within the scope of the present disclosure. For example, the rotation elements 104 may include one or more gears, friction drives, and so forth. In another example, the electric motors 112 may be coupled to the respective bending plates 102 in a direct-drive configuration.

The electric motors 112, the belt and pulley assemblies 114 and the bending plates 102 are supported by the support structure 103. The support structure 103 includes a pair of base plates 120. Each base plate 120 is coupled to the respective bending plate 102 such that the respective bending plate 102 is rotatable relative to the base plate 120. Each of the rotation elements 104 is mounted on a respective base plate 120 from the pair of base plates 120. In some cases, each of the base plates 120 may be made of a metallic material, such as black anodized aluminum. In some cases, each of the base plates 120 may have rounded or chamfered corners to remove sharp edges. In some cases, the electric motor 112 is coupled to the respective base plate 120 via a motor clamp 113. The support structure 103 further includes a support plate 122 for supporting the pair of base plates 120 thereon. In some cases, the support plate 122 may be made of a metallic material, such as black anodized aluminum. In some other cases, the support plate 122 may have rounded or chamfered corners to remove sharp edges. In some embodiments, each of the base plates 120 may have a generally planar shape. Similarly, the support plate 122 may have a generally planar shape. In some embodiments, the base plates 120 are coupled to the support plate 122 via respective sets of base fasteners 123. Each of the base plates 120 defines a longitudinal axis “L1” and a lateral axis “L2”. The longitudinal axis “L1” may be generally parallel to the Y-axis, while the lateral axis “L2” may be generally parallel to the X-axis. In the illustrated embodiment, the pair of base plates 120 are offset with respect to each other along the longitudinal axis “L1” of at least one of the pair of base plates 120. Specifically, a longitudinal offset “OL” is provided between proximal lateral edges 124 of the base plates 120. The longitudinal offset “OL” may result in a longitudinal offset “OP” (shown in FIG. 3) between the first and second bending plates 102A, 102B. The longitudinal offset “OP” may be defined between proximal lateral edges 131 of the bending plates 102. In the illustrated embodiment, one of the base plates 120 is adjustably coupled to the support plate 122.

In some embodiments, at least one of the pair of base plates 120 defines at least one base slot 125. Specifically, the base plate 120 corresponding to the first bending plate 102A defines the at least one base slot 125. In the illustrated embodiment, the base plate 120 includes a pair of base slots 125 spaced apart from each other with respect to the longitudinal axis “L1” of the base plate 120. In some embodiments, each of the base slots 125 has an elongate configuration extending along the lateral axis “L2” of the base plate 120. In some embodiments, the at least one base slot 125 receives a base fastener 123 therethrough for coupling the base plate 120 to the support plate 122. Specifically, the pair of base slots 125 receives respective base fasteners 123 for adjustably coupling the base plate 120 to the support plate 122. In a loosened state of the base fastener 123, the base plate 120 is movable along a length of the at least one base slot 125 such that a gap between the pair of base plates 120 is adjustable. Specifically, in the loosened state of each of the base fasteners 123, the base plate 120 corresponding to the first bending plate 102A is movable relative to the support plate 122 in order to adjust the gap between the base plates 120. In some embodiments, the gap between the base plates 120 may be the gap disposed along the lateral axis “L2” of each of the base plates 120. In other words, the gap between the base plates 120 is disposed along the X-axis. In the illustrated embodiment, the base plate 120 corresponding to the first bending plate 102A is adjustably mounted on the support plate 122. In some cases, the base plate 120 corresponding to the second bending plate 102B may be non-adjustably mounted on the support plate 122 via the base fasteners 123. Alternatively, the base plate 120 corresponding to the second bending plate 102B may be adjustably mounted on the support plate 122 via the base fasteners 123 received through the respective base slots 125.

In some embodiments, the support structure 103 of the apparatus 100 further includes a pair of bearing blocks 126 coupled to each of the pair of base plates 120, a pair of shafts 128 rotatably received through the respective bearing blocks 126, and a pair of moving arms 130 coupled to respective shafts 128. The pair of bearing blocks 126, the pair of shafts 128 and the pair of moving arms 130 are provided for each bending plate 102. The support structure 103 of the apparatus 100 may therefore include four bearing blocks 126, four shafts 128 and four moving arms 130. The pair of shafts 128 are rotatable about a respective rotational axis “R1” or “R2” from the first rotational axis “R1” and the second rotational axis “R2”. In other words, the pair of shafts 128 corresponding to the first bending plate 102A is rotatable about the first rotational axis “R1”. The pair of shafts 128 (not shown in FIGS. 1 to 3) corresponding to the second bending plate 102B is rotatable about the second rotational axis “R2”. At least one of the pair of shafts 128 is operably coupled to a respective rotation element 104 from the pair of rotation elements 104. Therefore, each of the rotation elements 104 further includes the electric motor 112, and the belt and pulley assembly 114 configured to operably couple the electric motor 112 to the at least one of the pair of shafts 128. Each of the pair of moving arms 130 is further coupled to the respective bending plate 102. In some cases, the moving arms 130 are disposed proximal to respective lateral edges 131 of the respective bending plate 102. In some other cases, the shafts 128 and the bearing blocks 126 are disposed proximal to the respective lateral edges 131 of the respective bending plate 102. In other words, the pair of shafts 128, the pair of bearing blocks 126 and the pair of moving arms 130 may be disposed proximal to respective opposing sides of the respective bending plate 102. In some embodiments, each of the bearing blocks 126 is coupled to the respective base plate 120 via a pair of block fasteners 132. In some cases, the bearing blocks 126 may be made of a metallic material, such as aluminum. In some other cases, each of the shafts 128 may also be made of a metallic material, such as aluminum. In some cases, one of the shafts 128 is coupled to the plate pulley 118 and drives the respective moving arm 130 from one side. In some cases, the other shaft 128 is not driven and supports rotation of the respective bending plate 102 from the opposite side. The apparatus 100 may therefore include two shafts 128 that are driven and two shafts 128 that are not driven. The rotation elements 104 for the respective bending plates 102 are disposed opposite to each other with respect to the bending plates 102. Further, the shafts 128 that are driven are also disposed opposite to each other with respect to the bending plates 102. Similarly, the shafts 128 that are not driven are also disposed opposite to each other with respect to the bending plates 102. In some embodiments, the shafts 128 that are driven may have a different configuration from the shafts 128 that are not driven. The shafts 128 are coupled to the respective moving arms 130. In some cases, each of the moving arms 130 may be made of a metallic material, such as aluminum. In some cases, one of the moving arms 130 receives rotational power from the respective shaft 128 and rotates the respective bending plate 102. In some other cases, the other moving arm 130 is not driven and supports the rotation of the respective bending plate 102. In some embodiments, each of the moving arms 130 may be generally L-shaped. In some other embodiments, each of the moving arms 130 is coupled to the respective bending plate 102 via a pair of arm fasteners 133 and a lock member 135 that receives the arm fasteners 133. Alternatively, the moving arm 130 may be coupled to the respective bending plate 102 via at least one arm fastener 133.

In some embodiments, each of the first and second bending plates 102A, 102B, the respective base plate 120, the respective rotation element 104 including the electric motor 112 and the belt and pulley assembly 114, the respective bearing blocks 126, the respective shafts 128, and the respective moving arms 130 form a bending unit 134. The apparatus 100 therefore includes two independent bending units 134 that are substantially identical to each other and mounted on the support plate 122. In some embodiments, spacing between the bending units 134 may be adjustable. Further, various parameters associated with the bending units 134 may be adjustable independently of each other. For example, the first and second bending plates 102A, 102B may be moved independently or simultaneously.

In some embodiments, each of the first bending plate 102A and the second bending plate 102B is rotatable in an angular range. Specifically, the first bending plate 102A and the second bending plate 102B are rotatable about the first rotational axis “R1” and the second rotational axis “R2” in respective angular ranges. In some embodiments, the angular ranges corresponding to the first bending plate 102A and the second bending plate 102B may be substantially equal to each other. Alternatively, the angular ranges may be different from each other. In some embodiments, the angular ranges of the first and second bending plates 102A. 102B may be independently adjustable. In some embodiments, the angular range of each of the first bending plate 102A and the second bending plate 102B is from about 90 degrees to about 180 degrees. In the illustrated embodiment, the angular range of each of the first bending plate 102A and the second bending plate 102B is about 90 degrees. The angular range of motion of each of the first and second bending plates 102A, 102B may be defined with respect to the X-Y plane of the apparatus 100.

In some embodiments, each of the first and second bending plates 102A, 102B is rotatable between a respective first position and a respective second position. The angular range of motion of each of the first and second bending plates 102A, 102B may correspond to an angular difference between the respective first position and the respective second position. In the first position, as illustrated in FIG. 1, the first and second bending plates 102A, 102B may be positioned generally parallel to the respective base plates 120. In other words, the first position may correspond to a generally horizontal position of each of the first and second bending plates 102A, 102B. However, the first position may correspond to any lowered position of each of the first and second bending plates 102A, 102B with respect to the respective base plates 120. In the second position, as illustrated in FIG. 3, the first and second bending plates 102A, 102B may be positioned generally perpendicular to the respective base plates 120. In other words, the second position may correspond to a generally vertical position of each of the first and second bending plates 102A, 102B. However, the second position may correspond to any raised position of each of the first and second bending plates 102A, 102B with respect to the respective base plates 120. In the second position, the first and second bending plates 102A, 102B may oppose each other, i.e., the front surfaces 106 of the first and second bending plates 102A, 102B may face each other. An intermediate position of each of the first and second bending plates 102A, 102B between the respective first position and the respective second position is illustrated in FIG. 2. The first position and the second position of each of the first and second bending plates 102A, 102B may be measured with respect to the X, Y and Z-axes of the apparatus 100. Alternatively, the first and second positions may be measured as angular positions with respect to the X-Y plane of the apparatus 100. In some embodiments, at least one of the first position and the second position of each of the first bending plate 102A and the second bending plate 102B is adjustable. In some other embodiments, the first position and the second position of each of the first bending plate 102A and the second bending plate 102B may be independently adjustable. Each of the first and second positions may be adjustable with respect to the X, Y and Z-axes.

In the illustrated embodiment, a gap “GH” is provided between proximal ends 136 of the first and second bending plates 102A, 102B in the respective first positions, i.e., the gap “GH” (shown in FIG. 1) is provided between first and second bending plates 102A, 102B in the respective first positions. In other embodiments, the proximal ends 136 of the first and second bending plates 102A, 102B may abut each other in the respective first positions, i.e., no gap is provided between first and second bending plates 102A, 102B in the respective first positions. In some cases, the gap “GH” between the first and second bending plates 102A, 102B in the respective first or lowered positions may be related to a gap (not shown in FIGS. 1 to 3) between the base plates 120. In other words, the gap “GH” between the first and second bending plates 102A, 102B in the respective first or generally horizontal positions may be related to the gap between the base plates 120. In some cases, the bending units 134 may be mounted on the support plate 122 such that the gap is provided between the base plates 120. In some cases, changes made to the gap between the base plates 120 may directly change the gap “GH” between the first and second bending plates 102A, 102B in the respective first positions.

In some embodiments, an offset “OH1” or “OH2” is provided between a proximal end 136 of each bending plate 102 and the respective rotational axis “R1” or “R2”. The offset “OH1” is a first offset corresponding to the first bending plate 102A. The offset “OH2” is a second offset corresponding to the second bending plate 102B. Each of the offsets “OH1” and “OH2” may be a generally horizontal offset between the proximal end 136 of the respective bending plate 102 and the respective rotational axis “R1” or “R2”. The proximal end 136 may correspond to a longitudinal edge of each bending plate 102 that is located proximal to the respective rotational axis “R1” or “R2”. In some embodiments, the offset “OH1” or “OH2” between the proximal end 136 of the respective bending plate 102 and a respective rotational axis “R1” or “R2” from the first rotational axis “R1” and the second rotational axis “R2” is adjustable. Specifically, the respective bending plate 102A or 102B is adjustably mounted on a respective base plate 120 such that the respective offset “OH1” or “OH2” between the proximal end 136 of the respective bending plate 102A or 102B and the respective rotational axis from the first rotational axis “R1” and the second rotational axis “R2” is adjustable. In some cases, the offsets “OH1” and “OH2” corresponding to the first and second bending plates 102A, 102B may be independently adjustable. Each of the first and second bending plates 102A, 102B may be adjustably mounted on the respective pair of moving arms 130 such that the respective offset “OH1” or “OH2” between the respective rotational axis “R1” or “R2” and the proximal end 136 of the respective bending plate 102 is adjustable. In some embodiments, the offsets “OH1” and “OH2” may be substantially equal to each other. In other embodiments, the offsets “OH1” and “OH2” may have different values.

In some embodiments, a gap “GA” is provided between the first rotational axis “R1” and the second rotational axis “R2”. The gap “GA” may be a horizontal offset between the first and second rotational axes “R1”, “R2”. In other words, the gap “GA” may be disposed substantially parallel to the X-axis. In some embodiments, the gap “GA” between the first rotational axis “R1” and the second rotational axis “R2” is adjustable and directly related to the gap between the base plates 120. In an embodiment, the gap “GA” may be related to the gap “GH” between the first and second bending plates 102A, 102B in the respective first positions, and the offsets “OH1” and “OH2”. In some embodiments, the gap “GA” may be independently adjustable. In some other embodiments, the gap “GA” may be adjustable due to adjustment of the gap “GH” and/or the offsets “OH1” and “OH2”.

In some embodiments, the apparatus 100 further includes a controller 138 communicably coupled to the pair of rotation elements 104. Specifically, the controller 138 may be communicably to the electric motors 112 of the rotation elements 104. The controller 138 is configured to control the pair of rotation elements 104 to rotate the first bending plate 102A and the second bending plate 102B independently from each other about the first rotational axis “R1” and the second rotational axis “R2”, respectively. Specifically, the controller 138 is configured to control the respective electric motors 112 to rotate the first bending plate 102A and the second bending plate 102B independently from each other about the first rotational axis “R1” and the second rotational axis “R2”, respectively. Each rotation element 104 is configured to selectively rotate the respective bending plate 102A or 102B from the first bending plate 102A and the second bending plate 102B based upon control signals received from the controller 138.

In some embodiments, the controller 138 is configured to regulate one or more parameters of the apparatus 100. The one or more parameters includes at least one of: an angular speed of each of the first bending plate 102A and the second bending plate 102B; the first position of each of the first bending plate 102A and the second bending plate 102B; the second position of each of the first bending plate 102A and the second bending plate 102B; a first delay at the first position of each of the first bending plate 102A and the second bending plate 102B; a second delay at the second position of each of the first bending plate 102A and the second bending plate 102B; a motion profile of each of the first bending plate 102A and the second bending plate 102B; and a number of cycles of bending. Each cycle includes a to-and-fro rotation of each of the first bending plate 102A and the second bending plate 102B between the first position and the second position. Specifically, each cycle includes a rotational motion from the first position to the second position, followed by a rotational motion from the second position to the first position. The number of cycles of bending may be adjusted by regulating the electric motors 112.

The angular speed or velocity of each of the first and second bending plates 102A, 102B may be a rate of change of angular position with respect to time for the respective bending plate 102. The speed of each of the first and second bending plates 102A, 102B may be adjusted by adjusting a rotational speed of the respective electric motor 112.

Adjusting the first position and the second position of each bending plate 102 may include adjusting the first and second positions with respect to the X-axis, Y-axis and/or the Z-axis of the apparatus 100. Alternatively, adjusting the first and second positions of each bending plate 102 may include adjusting the respective angular positions with respect to the X-Y plane. The lowered position and/or the raised position of each of the first and second bending plates 102A, 102B may be adjustable. Consequently, the angular range of motion between the first and second positions of each of the first and second bending plates 102A, 102B may be adjustable. In some cases, the first and second positions of each of the first and second bending plates 102A, 102B may be adjusted by regulating a direction of travel of the respective electric motor 112 during operation of the apparatus 100. For example, the first position may be determined by a change in a direction of rotation of the electric motor 112 when the respective bending plate 102 is proximal to the base plate 120. Further, the second position may be determined by a change in a direction of rotation of the electric motor 112 when the respective bending plate 102 is distal to the base plate 120.

In some embodiments, the first delay at the first position of each of the first and second bending plates 102A, 102B may be a time period during which the respective bending plate 102 is substantially stationary at the first position. Similarly, the second delay at the second position of each of the first and second bending plates 102A, 102B may be a time period during which the respective bending plate 102 is substantially stationary at the second position. In some cases, the first and second delays may be adjusted by adjusting the time periods during which the electric motors 112 are not providing rotational motion at the first and second positions. Specifically, the first delay may correspond to the time period during which the electric motor 112 does not provide any rotational motion before changing the direction of rotation at the first position of the respective bending plate 102. In some cases, the second delay may correspond to the time period during which the electric motor 112 does not provide any rotational motion before changing the direction of rotation at the second position of the respective bending plate 102.

In some cases, the motion profile for each of the first and second bending plates 102A, 102B may be determined by positions of the respective bending plate 102 at various instances of time. The motion profile may therefore indicate the positions of the respective bending plate 102 with respect to time. The positions may be measured with respect to the X, Y and Z-axes (shown in FIG. 1). A reference plane may correspond to the first position or the generally horizontal position of each bending plate 102. In some cases, the motion profile of each of the first and second bending plates 102A, 102B may be a partial trapezoidal profile, a ramp profile, or a modified sine profile. In some other cases, the motion profile may result in a variable velocity of each bending plate 102 during oscillating or to-and-fro motion between the first and second positions.

In some cases, the controller 138 may include a processor, a memory, input/output (I/O) interfaces, communication interfaces and other components. In some cases, the processor may execute various instructions stored in the memory for carrying out various operations of the controller 138. In some other cases, the controller 138 may receive and transmit signals and data through the I/O interfaces and the communication interfaces. In further embodiments, the controller 138 may include microcontrollers, application-specific integrated circuits (ASICs), field programmable gate arrays (FPGAs), and so forth. In some cases, the controller 138 may include one control unit or multiple control units communicably coupled to each other. For example, the controller 138 may include a microcontroller communicably coupled to one or more motor drivers that are communicably coupled to the electric motors 112. In some cases, the controller 138 may transmit control signals to the motor drivers, which in turn regulate the electric motors 112.

In some embodiments, the controller 138 may be further configured to control the pair of rotation elements 104 including the electric motors 112 based on proportional-integral-derivative (PID) control. PID control of the electric motors 112 may be part of a PID control algorithm. For example, the controller 138 may apply a correction based on proportional, integral, and derivative terms of an estimated error value. In some cases, the error value may be a difference between a target or expected position of each of the bending plates 102 and the current position of each of the bending plates 102 as determined by one or more sensors. In some embodiments, the controller 138 may be further configured to control the pair of rotation elements 104 based on at least one of a gravity offset and an acceleration offset. In some cases, the gravity offset may compensate for the effect of gravity on the bending plates 102. In some other cases, the gravity offset may be proportional to a mass of each bending plate 102, an effective distance of the mass of each bending plate 102 from the corresponding rotational axis “R1” or “R2”, and an angle of inclination of each bending plate 102 with respect to the horizontal. In some cases, the acceleration offset may compensate for the effect of angular acceleration on the bending plates 102. In some other cases, the acceleration offset may be proportional to a moment of inertia of each bending plate 102 and an angular acceleration of each bending plate 102. In some cases, the gravity offset and the acceleration offset may be experimentally determined. In some embodiments, PID control, the acceleration offset and the gravity offset may be incorporated in a set of instructions executable by the controller 138. The set of instructions may be based on a control algorithm implementable by the controller 138. In some cases, the set of instructions may also be part of a software code.

In some embodiments, the apparatus 100 further includes a pair of sensors communicably coupled to the controller 138. In some embodiments, each of the pair of sensors is configured to generate signals indicative of an angular position of the respective bending plate 102. The controller 138 is further configured to regulate the one or more parameters based on the signals received from the pair of sensors. In some embodiments, each of the pair of sensors is at least one of an encoder and a photo-sensor. For example, the controller 138 may receive signals from the encoders associated with the respective electric motors 112. Alternatively or additionally, the controller 138 may receive signals from onboard sensors 140 (hereinafter referred to as “the sensors 140”) of the apparatus 100. In some embodiments, the controller 138 is configured to regulate the one or more parameters based on one or more user inputs received at a user interface 142 associated with the controller 138. In some cases, the user interface 142 may be an onboard user interface or a remote user interface.

In some cases, the controller 138 may be communicably coupled to various devices, such as the electric motors 112 and the sensors, by wired connections, wireless communication, or a combination of both. In some other cases, the controller 138 may also communicate with external memory devices (e.g., flash drives, optical discs etc.), servers and user terminals (e.g., smartphones, personal computers (PCs), tablet computers etc.). The controller 138 may also utilize any suitable combination of communication protocols for communicating with other devices.

In the illustrated embodiment of FIG. 3, a flag 144 is coupled to at least one of the pair of moving arms 130. Each of the first and second bending plates 102A, 102B is provided with one flag 144 (only shown in FIG. 3). In some cases, the flag 144 is coupled to the moving arm 130 that is disposed distal to the belt and pulley assembly 114. In other words, the flag 144 is disposed proximal to the lateral edge 131 of the respective bending plate 102 opposite to the belt and pulley assembly 114. In some embodiments, the flag 144 extends along a direction “D 1” that is substantially perpendicular to the respective rotational axis “R1” or “R2”. In some cases, the flag 144 may extend generally perpendicular from a corresponding portion of the moving arm 130. The flag 144 may rotate along with the moving arm 130 about the respective rotational axis “R1” or “R2”. In some cases, the flag 144 may be coupled to the moving arm 130 via a mechanical fastener. In some cases, the flag 144 may have a generally planar shape. In some other cases, the flag 144 may be made of a metallic material, such as aluminum. In some embodiments, the apparatus 100 further includes the sensor 140 coupled to a respective base plate 120. Each of the first and second bending plates 102A, 102B is provided with one sensor 140 (one shown in FIG. 3). In some cases, the sensor 140 is disposed adjacent to the moving arm 130 that is coupled to the flag 144. In some cases, the sensor 140 is disposed proximal to the lateral edge 131 that is opposite to the belt and pulley assembly 114. In some embodiments, the sensor 140 includes a pair of elongate portions 146 spaced apart from each other. The flag 144 is configured to be disposed between the elongate portions 146 of the sensor 140 in at least one position of the respective bending plate 102. In the illustrated embodiment, the flag 144 is disposed between the elongate portions 146 of the sensor 140 in the first position (shown in FIG. 1) of the respective bending plate 102. In some embodiments, the sensor 140 is configured to generate a signal when the flag 144 is disposed between the elongate portions 146. In some other embodiments, the controller 138 is further configured to control the respective rotation element 104 including the electric motor 112 based on the signal received from the sensor 140. In some cases, the sensor 140 may be a photo-sensor that generates signals indicative of an angular position of the respective bending plate 102. Further, the sensor 140 may be a photogate sensor. In some cases, the sensor 140 may generate a signal indicating that the respective bending plate 102 is in the first position.

In some embodiments, the apparatus 100 further includes a clamping member 148 configured to adjustably mount the sensor 140 on the respective base plate 120. In some embodiments, the clamping member 148 is coupled to the respective base plate 120 by a clamping fastener 150. In a loosened state of the clamping fastener 150, the sensor 140 is slidable relative to the respective base plate 120 to adjust at least one position of the respective bending plate 102.

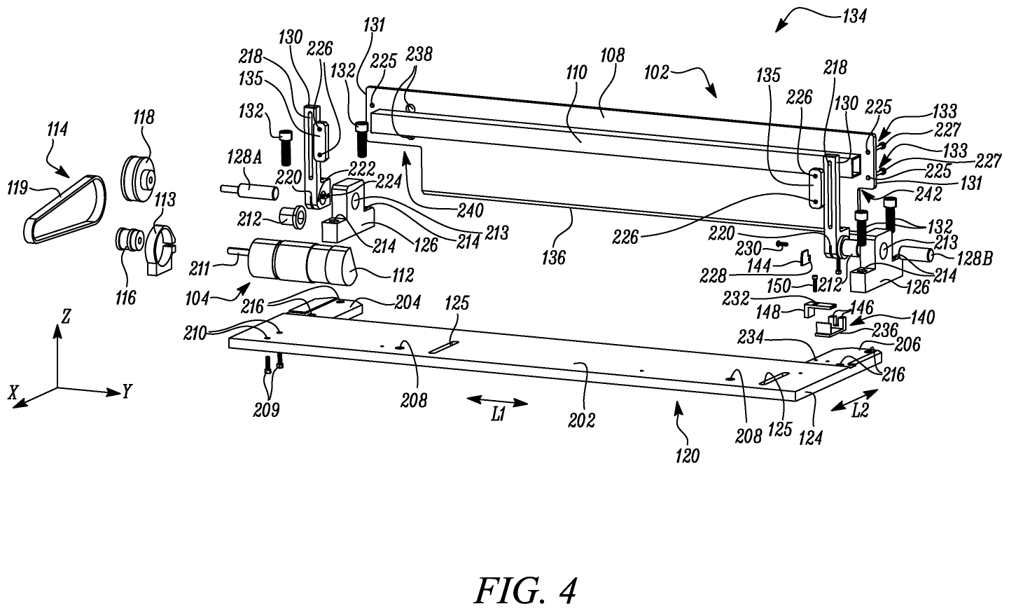

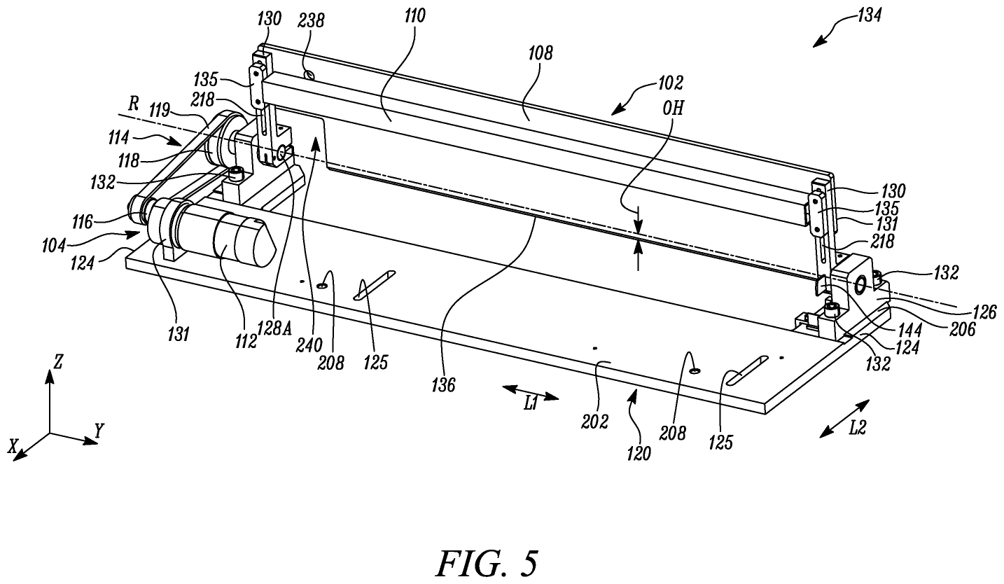

FIGS. 4 and 5 illustrate an exploded view and an assembled view, respectively, of one of the bending units 134. The bending unit 134 may correspond to any of the first and second bending plates 102A, 102B. The bending plate 102, shown in FIGS. 4 and 5, may be any one of the first and second bending plates 102A, 102B. Referring to FIGS. 4 and 5, the base plate 120 includes a main portion 202, a first mounting portion 204 extending from the main portion 202, and a second mounting portion 206 extending from the main portion 202 and spaced apart from the first mounting portion 204 with respect to the longitudinal axis “L1”. In some cases, the main portion 202 has a generally rectangular shape and defines multiple apertures for receiving mechanical fasteners. In some other cases, the main portion 202 also defines at least one base slot 125. In the illustrated embodiment, the main portion 202 defines the pair of base slots 125 spaced apart from each other with respect to the longitudinal axis “L1”. Each base slot 125 extends along the lateral axis “L2”. In some cases, the main portion 202 further defines a pair of securing apertures 208. In some embodiments, the base plate 120 may be adjustably mounted on the support plate 122 (shown in FIG. 1) via the base fasteners 123 received in the respective base slots 125. In other embodiments, the base plate 120 may be non-adjustably mounted on the support plate 122 via the base fasteners 123 received in the respective securing apertures 208. In some cases, each of the securing apertures 208 may be spaced apart from the adjacent base slot 125 in order to account for the longitudinal offset “OL” (shown in FIG. 1) between the base plates 120. In some cases, the first and second mounting portions 204, 206 are disposed adjacent to the respective lateral edges 124 of the base plate 120. In some cases, each of the first and second mounting portions 204, 206 extend from the main potion 202 along the lateral axis “L2”. In some other cases, each of the first and second mounting portions 204, 206 also includes multiple apertures for receiving mechanical fasteners. In some cases, the electric motor 112 is mounted on the base plate 120 via the motor clamp 113 proximal to the lateral edge 124 that is adjacent to the first mounting portion 204. In some cases, the motor clamp 113 is coupled to the base plate 120 via a pair of retaining fasteners 209 received in corresponding motor apertures 210 of the base plate 120. In some cases, each of the retaining fasteners 209 may be a screw. In some cases, the motor clamp 113 has split ends connected by a motor fastener (not shown), such as a bolt. In case the belt 119 gets loosened and requires tensioning, the motor fastener may be loosened and the electric motor 112 rotated for tensioning the belt 119. After belt tensioning, the motor fastener may be tightened again. In some cases, an output shaft 211 of the electric motor 112 is coupled to the motor pulley 116. The output shaft 211 may be coupled to the motor pulley 116 via a mechanical faster, such as a bolt (not shown).

In some embodiments, the pair of shafts 128 of the bending unit 134 includes a driven shaft 128A and a support shaft 128B. The driven shaft 128A is driven by the electric motor 112 via the belt pulley assembly 114. In some cases, the driven shaft 128A may have a stepped configuration. A narrow portion of the driven shaft 128A may be coupled to the plate pulley 118. In some cases, the driven shaft 128A may be coupled to the plate pulley 118 via a mechanical fastener, such as a belt (not shown). In some other cases, a wide portion of the driven shaft 128A may be coupled to a bushing 212. In some cases, the bushing 212 may be received in a hole 213 of the respective bearing block 126. The bushing 212 may provide a bearing surface for rotation of the driven shaft 128A relative to the respective bearing block 126. The support shaft 128B may transmit rotational power from the plate pulley 118 to the bending plate 102 via the respective moving arm 130 at one end of the bending plate 102. The support shaft 128B may rotationally support the bending plate 102 via the respective moving arm 130 at the opposite end of the bending plate 102. In some cases, the support shaft 128B may have a generally uniform width and is coupled to the respective bushing 212. The bushing 212 may provide a bearing surface for rotation of the support shaft 128B relative to the respective bearing block 126. In some cases, each of the bearing blocks 126 is coupled to the base plate 120 via the respective pair of block fasteners 132 received through corresponding block apertures 214 of the bearing block 126. In some cases, the bearing block 126 that is located adjacent to the belt and pulley assembly 114 is mounted on the first mounting portion 204 of the base plate 120. In some cases, the corresponding block fasteners 132 are received in corresponding mounting apertures 216 defined in the first mounting portion 204. In some other cases, the bearing block 126 located opposite to the belt and pulley assembly 114 is mounted on the second mounting portion 206 of the base plate 120. In some cases, the corresponding block fasteners 132 are received in corresponding mounting apertures 216 defined in the second mounting portion 206. In some cases, each of the block fasteners 132 may be a screw.

In some cases, each of the moving arms 130 may have a generally L-shaped configuration. In some embodiments, each of the moving arms 130 further defines an arm slot 218, a flag slot 220, an arm hole 222, and a shaft opening 224. In some cases, the arm slot 218 may be defined in a vertical portion of the moving arm 130. In some cases, the flag slot 220 may be disposed adjacent to a lower end of the moving arm 130. In some cases, the arm hole 222 may communicate with the flag slot 220 on both sides. In some cases, the shaft opening 224 may be defined by split sections disposed in a horizontal portion of the moving arm 130. In some embodiments, the arm slot 218 receives at least one arm fastener 133 therethrough for coupling the moving arm 130 to the respective bending plate 102. In a loosened state of the at least one arm fastener 133, the respective bending plate 102 is movable along a length of the arm slot 218 to adjust an offset “OH1” or “OH2” (shown in FIG. 1) between the respective rotational axis “R1” or “R2” (shown in FIG. 1) and the proximal end 136 of the respective bending plate 102. As shown in FIG. 5, a rotational axis “R” may represent each of the first and second rotational axes “R1”, “R2”. An offset “OH” may represent each of the offsets “OH1” and “OH2”. In the illustrated embodiment of FIGS. 4 and 5, a pair of arm fasteners 133 are received through corresponding coupling apertures 225 defined in the bending plate 102 and the arm slot 218 of the corresponding moving arm 130. In some cases, the bending plate 102 defines two pairs of coupling apertures 225 disposed adjacent to the respective lateral edges 131 for receiving the arm fasteners 133. In some cases, each pair of arm fasteners 133 may further be received in corresponding lock holes 226 of the respective lock member 135. In some cases, the lock member 135 may be disposed on the moving arm 130 such that the lock holes 226 of the lock member 135 are aligned with the respective arm fasteners 133. In some cases, each of the arm fasteners 133 may be a screw including a head 227. Upon loosening the arm fasteners 133, the bending plate 102 may be movable at least partially along the length of the arm slots 218 for adjusting the offset “OH”.

In some cases, each of the driven shaft 128A and the support shaft 128B are received in the shaft opening 224 of the respective moving arm 130. In some cases, a fastener may be received in holes (not shown) of the split sections of the moving arm 130 in order to secure each of the driven shaft 128A and the support shaft 128B to the respective moving arm 130. In some cases, the flag 144 may be at least partially received in the flag slot 220 of the moving arm 130 that is coupled to the support shaft 128B. In some cases, the flag 144 may further define a flag hole 228 that is aligned with the arm hole 222 of the moving arm 130. In some cases, a flag fastener 230 is received in the flag hole 228, the flag slot 220 and the arm hole 222 in order to couple the flag 144 to the moving arm 130. The flag fastener 230 may be a screw. In a coupled state, as shown in FIG. 5, the flag 144 extends along a direction “D 1” that is substantially perpendicular to the rotational axis “R”.

In some embodiments, the sensor 140 is adjustably coupled to the second mounting portion 206 of the base plate 120 via the clamping member 148 and the clamping fastener 150. In some cases, the clamping member 148 may have a generally L-shaped configuration. In some cases, the clamping fastener 150 may be received through a clamp opening 232 of the clamping fastener 150. In some other cases, the clamping fastener 150 may be further received in a sensor hole 234 defined in the second mounting portion 206 of the base plate 120. In some cases, the clamping fastener 150 may be a screw or a bolt. In some cases, the sensor 140 includes an planar portion 236 and the pair of elongate portions 146 extending from an end of the planar portion 236. The planar portion 236 is disposed between the clamping member 148 and the second mounting portion 206. In a loosened state of the clamping fastener 150, the sensor 140 is slidable relative to the respective base plate 120 to adjust at least one position of the bending plate 102. Specifically, the planar portion 236 of the sensor 140 is slidable relative to the base plate 120.

In some embodiments, the bending plate 102 further defines at least one access aperture 238 corresponding to a moving arm 130 from the pair of moving arms 130 coupled to an opposing bending plate 102. The at least one access aperture 238 is configured to allow access to the head 227 of the at least one arm fastener 133 coupling the moving arm 130 to the opposing bending plate 102. In the illustrated embodiment of FIGS. 4 and 5, the bending plate 102 includes two access apertures 238 for accessing the heads 227 of the respective arm fasteners 133 of the opposing bending plate 102. Such access may be required for loosening the arm fasteners 133 for adjusting the offset “OH”. In some cases, the access apertures 238 are provided adjacent to the lateral edge 131 that is proximal to the belt and pulley assembly 114. Access apertures 238 may not be required at the other lateral edge 131 as the heads 227 of the corresponding arm fasteners 133 of the opposing bending plate 102 may be accessible due to the longitudinal offset “OP” (shown in FIG. 3) between the bending plates 102.

In some embodiments, the bending plate 102 further includes a first cutout 240 and a second cutout 242 disposed adjacent to the respective lateral edges 131. In some cases, a size of the first cutout 240 may be greater than a size of the second cutout 242. In some other cases, the first cutout 240 may accommodate at least the bearing block 126 and the moving arm 130 of an opposing bending unit 134. In some cases, the second cutout 242 may be aligned with the respective moving arm 130.

In the assembled state, as shown in FIG. 5, the rotation element 104 of the bending unit 134 includes the electric motor 112 and the belt and pulley assembly 114. The rotation element 104 may rotate the bending plate 102 about the rotational axis “R” via the driven shaft 128A and the respective moving arm 130.

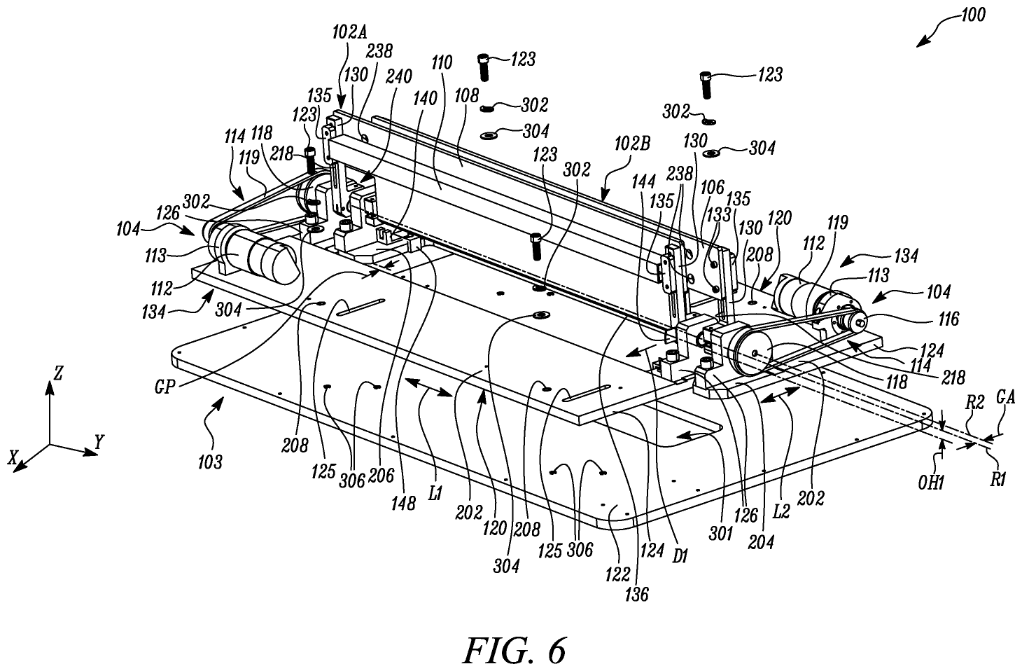

FIG. 6 illustrates an assembly of the two bending units 134 on the support plate 122 to form the apparatus 100. One of the bending units 134 includes the first bending plate 102A, while the other bending unit 134 includes the second bending plate 102B. In some cases, the support plate 122 may include a central opening 301 to facilitate mounting of the bending units 134. In some cases, each of the base plates 120 is coupled to the support plate 122 via a pair of base fasteners 123. In some cases, each of the base fasteners 123 may be screws. In some other cases, a first washer 302 and a second washer 304 may also be provided for each base fastener 123. In some cases, the base fasteners 123 for the base plate 120 corresponding to the first bending plate 102A may be received in the respective base slots 125. The base plate 120 corresponding to the first bending plate 102A may therefore be adjustably mounted on the support plate 122. In some cases, the base fasteners 123 for the base plate 120 corresponding to the second bending plate 102B may be received in the respective securing apertures 208. The base plate 120 corresponding to the second bending plate 102B may be non-adjustably mounted on the support plate 122. Alternatively or additionally, the base plate 120 corresponding to the second bending plate 102B may be adjustably mounted on the support plate 122. In some cases, the support plate 122 includes two sets of support apertures 306 for each base plate 120. In some other cases, each set of support apertures 306 includes two support apertures 306 aligned with the respective base slot 125 and the respective securing aperture 208. Each base plate 120 may be interchangeably coupled through the base slots 125 or the securing apertures 208 to the support plate 122. In some cases, the support apertures 306 in each set may be spaced apart from each other in order to account for the longitudinal offset “OL” (shown in FIG. 1) between the base plates 120. In some cases, the bending units 134 may be mounted on the support plate 122 with an offset between them such that the first mounting portion 204 of each base plate 120 is located adjacent to the second mounting portion 206 of the opposing base plate 120. Further, the first mounting portions 204 are located outwardly with respect to the second mounting portions 206 on respective sides. In some cases, the first cutout 240 of each bending plate 102 may allow such offset between the bending units 134 by accommodating at least the bearing block 126 and the moving arm 130 mounted on the second mounting portion 206 of the opposing base plate 120.

In some embodiments, the bending units 134 are further mounted on the support plate 122 such that a gap “GP” is provided between the base plates 120. The gap “GP” may be disposed between a longitudinal edge of the main portion 202 of each base plate 120 and a proximal edge of the second mounting portion 206 of the opposing base plate 120. The gap “GP” between the base plates 120 is adjustable due to the adjustable mounting of at least one of the base plates 120 on the support plate 122.

In some embodiments, the support structure 103 for rotatably supporting the first and second bending plates 102A, 102B may include the support plate 122, the two base plates 120, two driven shafts 128A, two support shafts 128B, four bearing blocks 126, four bushings 212 (shown in FIG. 4) and four moving arms 130.

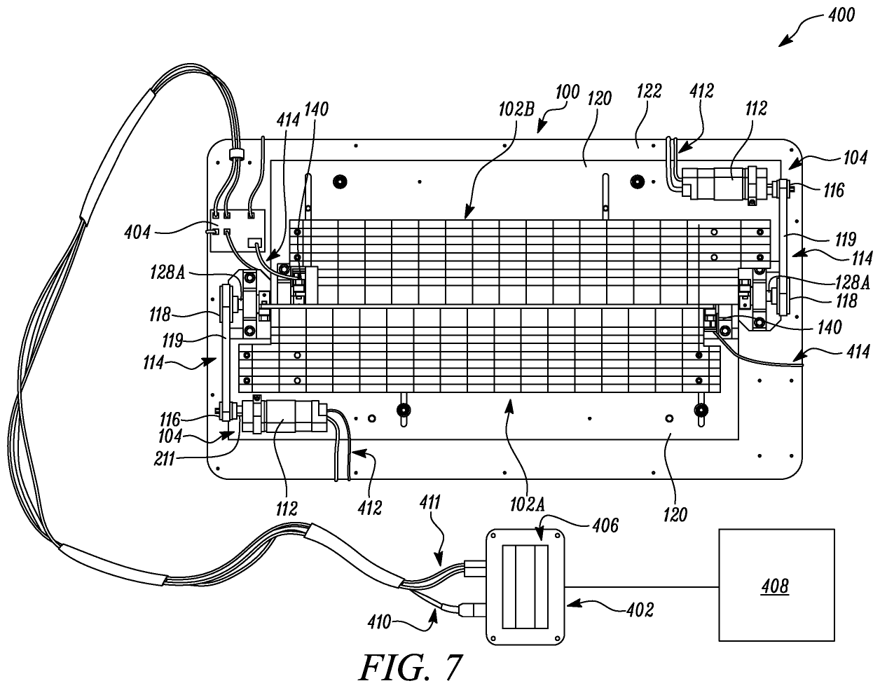

FIG. 7 illustrates a bending system 400 including the apparatus 100, a controller box 402 and a circuit board 404. In some embodiments, the controller box 402 includes a user interface 406. The controller 138 of FIG. 1 may be embodied as the controller box 402. The user interface 142 of FIG. 1 may be embodied as the user interface 406 of the controller box 402. In an example, the controller box 402 may include a microcontroller manufactured by Arduino. In some cases, the user interface 406 may be manufactured by Adafruit. In some cases, the user interface 406 may include a display and one or more buttons. In some cases, the display of the user interface 406 may be a liquid crystal display (LCD) screen. The controller box 402 may be powered by a power supply 408. In some cases, the power supply 408 may be a power adapter. In some embodiments, a set of control cables 410 connect the controller box 402 with the circuit board 404. In some cases, the control cables 410 may provide control signals to the circuit board 404. The control cables 410 may also transmit sensor signals to the controller box 402. In some cases, the controller box 402 may transmit power to the circuit board 404 via a set of power cables 411. In some cases, the controller box 402 may further include one or more motor drivers for regulating the electric motors 112. The motor drivers may include suitable circuitry for carrying out operations of the motor drivers. For example, the motor drivers may include one or more chips, inductors, connectors, conductive elements, capacitors, switches and so forth. In some cases, each motor driver may be a VNH5019 motor driver with an integrated H-bridge manufactured by Pololu. In some embodiments, the electric motors 112 are electrically connected to the circuit board 404 by respective sets of motor cables 412. In some embodiments, the sensors 140 are electrically connected to the circuit board 404 by respective sets of sensor cables 414. Alternatively, the sensors 140 may be directly connected to the controller box 402.

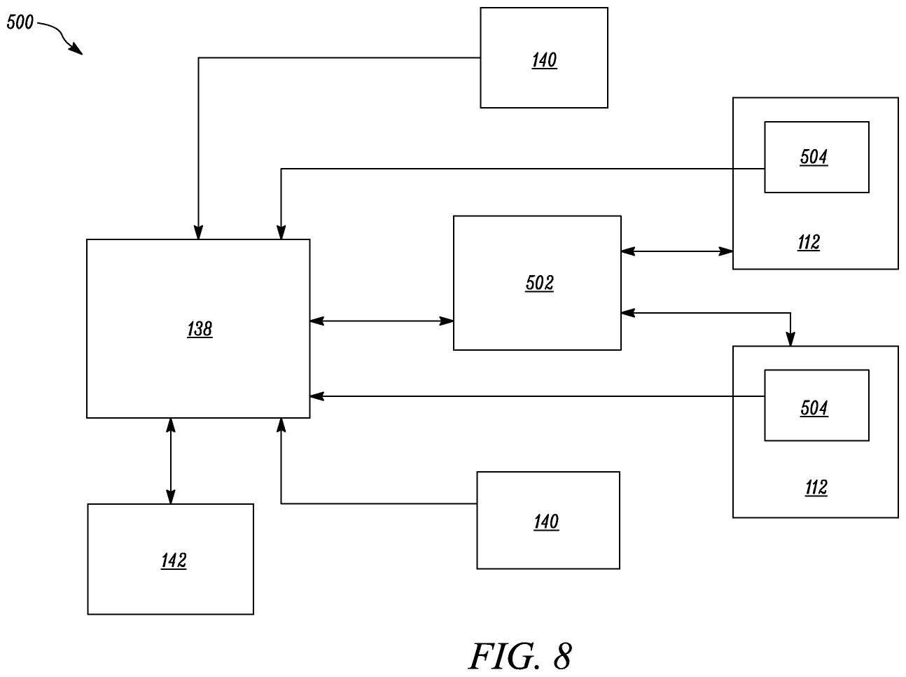

FIG. 8 illustrates a block diagram of a control system 500 associated with the apparatus 100 (shown in FIG. 1). The control system 500 includes the controller 138, a motor driver 502, the sensors 140, the electric motors 112, and encoders 504 associated with the respective electric motors 112. The controller 138 is communicably coupled to the motor driver 502, the sensors 140 and the encoders 504. The motor driver 502 is communicably coupled to the electric motors 112. Therefore, the controller 138 is communicably coupled to the electric motors 112 via the motor driver 502. The controller 138 may transmit control signals to the motor driver 502. In some cases, the motor driver 502 may regulate the electric motors 112 based on the control signals received from the controller 138. In some cases, the controller 138 may also receive signals from the sensors 140 and the encoders 504. The signals from the sensors 140 and the encoders 504 may be indicative of angular positions of the respective bending plates 102 (shown in FIG. 1). The controller 138 also communicates with the user interface 142. In some embodiments, the controller 138 may transmit control signals to the motor driver 502 based at least on one or more user inputs received at the user interface 142, the signals received from the sensors 140 and the encoders 504, and a set of instructions stored in the memory associated with the controller 138. In some other embodiments, the controller 138 may regulate or adjust various parameters associated with the apparatus 100.

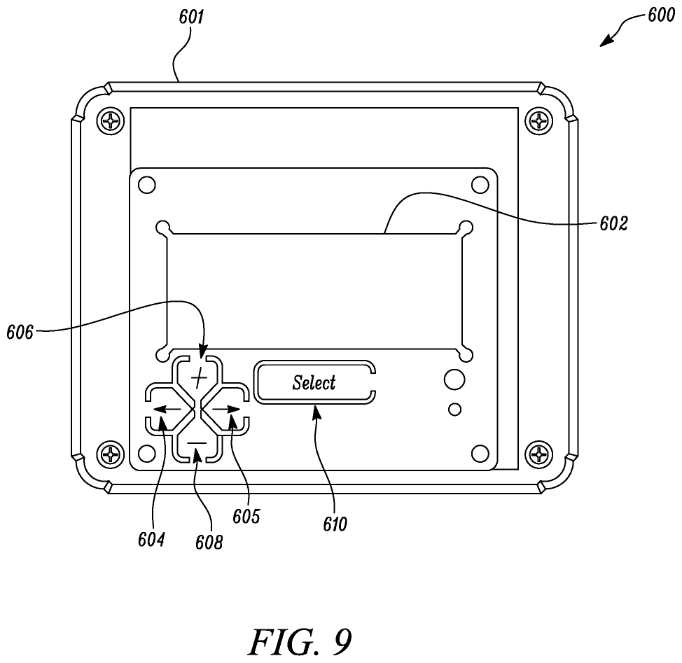

FIG. 9 illustrates a user interface 600 associated with the apparatus 100 (shown in FIG. 1). In some cases, the user interface 600 may be similar to the user interface 406 of the controller box 402 (shown in FIG. 7). The user interface 600 may be provided on a housing 601. In some cases, the housing 601 may be made of plastic. In the illustrated embodiment, the user interface 600 includes multiple buttons or keys and a display screen 602. In some cases, the display screen 602 may be an LCD screen. In some embodiments, the buttons include a left navigation button 604 and a right navigation button 605 indicated by left and right arrows, respectively. Further, the buttons include an increment button 606 indicated by a ‘+’ sign and a decrement button 608 indicated by a ‘-’ sign. The buttons further include a select button 610. The user interface 600 may therefore include five buttons.

In some cases, an operator may press the left and right navigation buttons 604, 605 to move through six fields. In some cases, a currently active field is identified by capital letters, or a chevron (<) in the display screen 602. In some cases, a value in the field is generally adjusted with the increment and decrement buttons 606, 608. In some other cases, some fields are activated by the select button 610. The user or operator may adjust various parameters of the apparatus 100 using the user interface 600.

Referring to FIGS. 1, 3 and 9, the operator may start or stop the apparatus 100 by pressing the select button 610. In some cases, the increment button 606 may be pressed to stop the apparatus 100 the next time each of the bending plates 102 reaches its upper limit or the second position (shown in FIG. 3). In some other cases, the decrement button 608 may be pressed to stop the apparatus 100 the next time each of the bending plates 102 reaches its lower limit or the first position (shown in FIG. 1).

In some embodiments, the operator may adjust the speed or velocity “V” of each of the bending plates 102 independently via the user interface 600. The velocity “V” may be the angular or rotational velocity of each of the bending plates 102. In some cases, the velocity “V” may be increased with the increment button 606. The velocity “V” may be decreased with the decrement button 608. In some cases, the units of the velocity “V” may be revolutions per minute (RPM) of each of the bending plates 102. In some other cases, one to-and-fro motion (up and down) of each bending plate 102 may be about 180 degrees with an angular range “AR” of motion of about 90 degrees or half a revolution.

In some embodiments, the operator may adjust the delay that occurs at each of the top and bottom motion limits (i.e., the first and second positions of each bending plate 102) via the user interface 600. In some cases, the operator may increase the first delay “DL1” at the first position of each of the bending plates 102 by pressing the increment button 606. The operator may decrease the first delay “DL1” at the first position of each of the bending plates 102 by pressing the decrement button 608. Similarly, the operator may increase the second delay “DL2” at the second position of each of the bending plates 102 by pressing the increment button 606. The operator may decrease the second delay “DL2” at the second position of each of the bending plates 102 by pressing the decrement button 608. In some cases, units for adjusting the delay may be in tenths of a second.

In some embodiments, the operator may adjust the angular range “AR” of motion of each of the bending plates 102 via the user interface 600. In some cases, the angular range “AR” may be increased with the increment button 606. The angular range “AR” may be decreased with the decrement button 608. The angular range “AR” may be the angular distance in degrees that each bending plate 102 moves from its lower limit or first position. In some cases, a step size of the angular range “AR” may be about 10 degrees.

In some embodiments, the operator may independently adjust a first home offset “H1” and a second home offset “H2” corresponding to the first and second bending plates 102A, 102B, respectively. The home position of each of the first and second bending plates 102A, 102B may correspond to the respective first position or down position. The first and second home offsets “H1”, “H2” may correspond to the offsets at the respective first positions of the first and second bending plates 102A, 102B. In some cases, the operator may adjust the first position or down position of each of the first and second bending plates 102A, 102B via the user interface 600. In some cases, the second bending plate 102B may be located proximal to the circuit board 404 in FIG. 7. In some cases, the first or second home offsets “H1”, “H2” of the first or second bending plates 102A, 102B may be increased with the increment button 606. Increasing the first or second home offsets “H1”, “H2” may raise the first or second bending plates 102A, 102B at the first position. The first or second home offsets “H1”, “H2” may be decreased with the decrement button 608. Decreasing the first or second home offsets “H1”, “H2” may lower the first or second bending plates 102A, 102B at the first position. In some cases, units of the first and second home offsets “H1”, “H2” may be in encoder counts, where one encoder count may be about 0.43 degree of rotation or about 0.75 mm movement at an edge of each bending plate 102. Similarly, the offsets at the second or raised positions of the first and second bending plates 102A, 102B may be independently adjusted via the user interface 600.

In some embodiments, the user interface 600 may also indicate an actual count “AC” of a number of bending cycles of the apparatus 100. Each cycle may include a to-and-fro motion of each bending plate 102. In some cases, the actual count “AC” may be displayed proximal to an upper left corner of the display screen 602. In some other cases, the operator may press the select button 610 to clear or reset the actual count “AC” back to zero. In some cases, the operator may also use the increment and decrement buttons 606, 608 to enter a debug mode. In the debug mode, diagnostics, tuning, maintenance and/or updates may be conducted. In some cases, the operator may press the decrement button 608 a few times to exit the debug mode if an active region of the display screen 602 does not include the actual count “AC” of cycles.

In some embodiments, the user interface 600 may further indicate a target count “TC” of a number of bending cycles of the apparatus 100. In some cases, the target count “TC” may be displayed proximal to an upper right corner of the display screen 602. In some cases, the target count “TC” may be increased by the increment button 606. Further, the target count “TC” may be decreased by the decrement button 608. In some cases, the target count “TC” may be changed by multiples of 100 up to 1000, then multiples of 1000 up to 10000, and so forth.

In some cases, the operator may use a predetermined relationship between cycles per minute (CPM) of the apparatus 100, the velocity “V” of each bending plate 102 in RPM, and the angular range “AR” of motion each bending plate 102 for calculating a desired CPM. For AR=90 degrees, CPM=2*V. In some cases, a stopwatch may be used to verify the CPM speed. The operator may count the number of cycles of the apparatus 100 that occur in one minute.

In some embodiments, the user interface 600 may be further used to adjust the motion profile of each of the first bending plate 102A and the second bending plate 102B. In some cases, the select button 610, and the left and right navigation buttons 604, 605 may be used to select a desired motion profile from a menu displayed on the display screen 602. Different motion profiles may be selected for the first and second bending plates 102A, 102B.

The user interface 600, as illustrated in FIG. 6, is exemplary in nature, and various other embodiments of the user interface 600 are possible within the scope of the present disclosure. For example, the user interface 600 may have a touchscreen, one or more ports to receive removable memory devices, etc. Further, the user interface 600 may be able to receive voice or gesture commands. The user interface 600 may be able to communicate with other devices, such as servers, smartphones, PCs, tablet computers, and so forth. The user interface 600 may also be able to execute remote commands from the operator.

In some embodiments, various inputs from the operator at the user interface 600 may be implemented by execution of a set of instructions or software code by a processor associated with the controller box 402 (shown in FIG. 7). Apart from the parameters that are adjustable using the user interface 600, the operator or user may also be able to adjust other parameters of the apparatus 100, as discussed below.

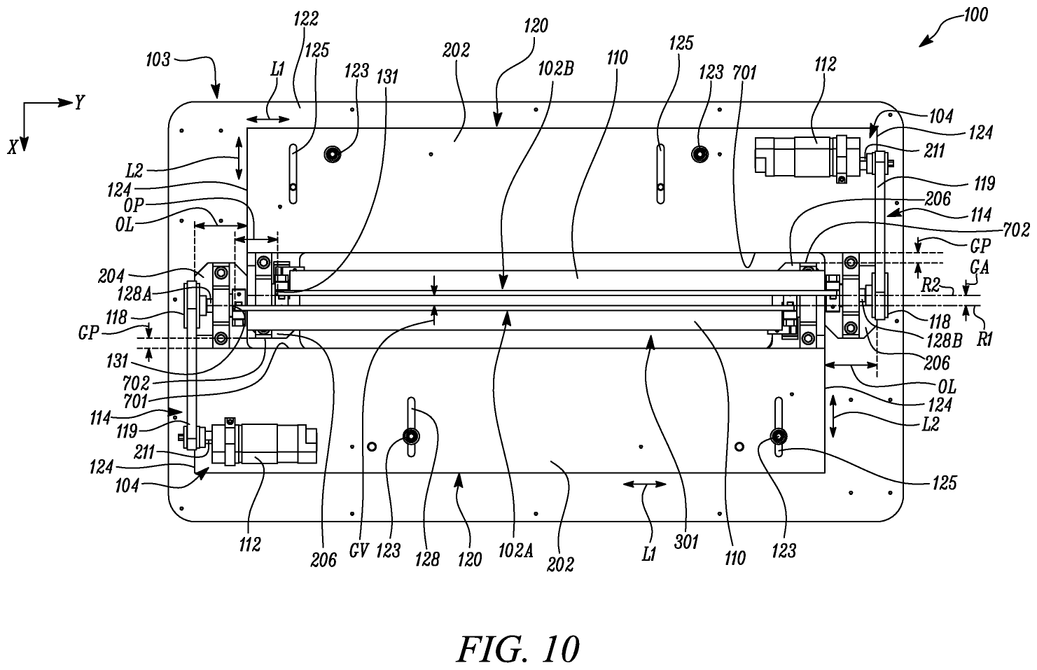

FIG. 10 illustrates a top view of the apparatus 100. An adjustment of the gap “GP” between the base plates 120 will be described with reference to FIG. 10. In some cases, the gap “GP” may correspond to the gap “GA” (shown in FIG. 1) between the first and second rotational axes “R1”, “R2”. In other words, due to a design of the apparatus 100, the gap “GP” between the base plates 120 may be substantially equal to the gap “GA” between the first and second rotational axes “R1”, “R2”. In some cases, the gap “GP” may be disposed between a longitudinal edge 701 of the main portion 202 of each base plate 120 and a proximal edge 702 of the second mounting portion 206 of the opposing base plate 120. The gap “GP” between the base plates 120 is adjustable due to the adjustable mounting of at least one of the base plates 120 on the support plate 122. Further, a gap “GV” is provided between the first and second plates 102A, 102B in the second or generally vertical position, as shown in FIG. 10. In some embodiments, the longitudinal offset “OL” may be defined between the proximal lateral edges 124 of the base plates 120. Similarly, the longitudinal offset “OP” may be defined between the proximal lateral edges 131 of the bending plates 102.

In the illustrated embodiment of FIG. 10, the base plate 120 corresponding to the first bending plate 102A is adjustably mounted on the support plate 122 via the pair of base fasteners 123 passing through the respective base slots 125 of the base plate 120. In some cases, the two base fasteners 123 may be loosened, and the base plate 120 slid along the length of each of base slots 125 to set the gap “GP between the pair of base plates 120 at a desired value. In some embodiments, the gap “GP” between the base plates 120 may be the gap disposed along the lateral axis “L2” of each of the base plates 120. In other words, the gap “GP” between the base plates 120 is disposed along the X-axis. Further, the base plate 120 that is adjustably mounted may be moved along the X-axis in order to control the gap “GP”. In some cases, a caliper or a gauge block may be used to set the desired value of the gap “GP” between the two base plates 120.

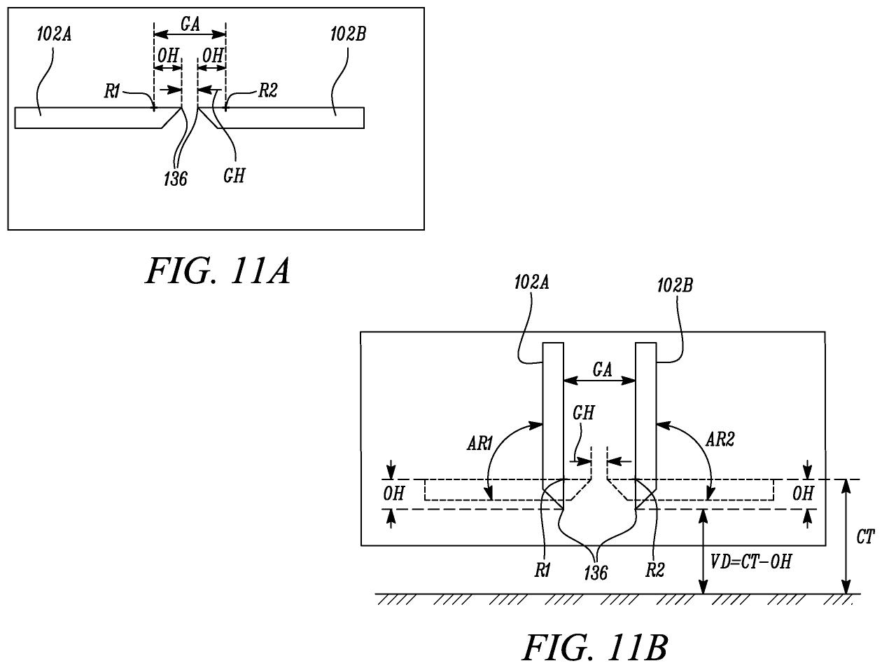

FIGS. 11A and 11B illustrate schematic views of the apparatus 100. The apparatus includes the first and second bending plates 102A, 102B rotatable about the respective first and second rotational axes “R1”, “R2”. Various components of the apparatus 100 are not shown in FIGS. 11A and 11B for the purposes of illustration. FIG. 11A illustrates the first and second bending plates 102A, 102B in the first position or generally horizontal position. FIG. 11B illustrates the first and second bending plates 102A, 102B in the second position or generally vertical position. The first bending plate 102A is rotatable in an angular range “AR1” between the respective first and second positions. The second bending plate 102B is rotatable in an angular range “AR2” between the respective first and second positions. Each of the angular ranges “AR1” and “AR2” may be about 90 degrees.

In the configuration illustrated in FIGS. 11A and 11B, the proximal ends 136 of the first and second bending plates 102A, 102B are separated by the gap “GH” in the first position. The first and second rotational axes “R1”, “R2” are separated by the gap “GA”. The gap “GA” may be a horizontal offset between the first and second rotational axes “R1”, “R2”. The gap “GA” may also be referred to as a distance between the pivot points of the first and second bending plates 102A, 102B. As discussed above with reference to FIG. 10, the gap “GP” between the base plates 120 may be substantially equal to the gap “GA” between the first and second rotational axes “R1”, “R2”. In some embodiments, the offset “OH” is provided between the proximal end 136 of each of the first and second bending plates 102A, 102B and the respective rotational axes “R1” and “R2”. The offset “OH” may be different for the first and second bending plates 102A, 102B in some configurations. The offset “OH” may correspond to each of the offsets “OH1” and “OH2” shown in FIG. 1. In some cases, the gap “GA” and the offset “OH” may be adjustable by a user. These parameters are related by Equation 1:

GA=2OH+GH Equation 1

Therefore,OH=(GA−GH)/2 Equation 2

It may be apparent from FIG. 11B that the gap “GV” (shown in FIG. 10) between the first and second bending plates 102A, 102B in the second or generally vertical position may be substantially equal to the gap “GA” between the first and second rotational axes “R1”, “R2”.

For adjustment of the parameters, “GA” and “GH” may be chosen and “OH” calculated by the above equation. For adjustment of the bending plates 102, a target vertical distance “VD” may be calculated based on the offset “OH” and a constant “CT”. “VD” may be provided by Equation 3;

VD=CT−OH Equation 3

In some cases, “CT” may be a vertical distance between each of the first and second rotational axes “R1” or “R2” and an upper surface of the support plate 122 (shown in FIG. 1). In other words, “CT” may be a distance between the proximal end 136 of each bending plate 102 and the upper surface of the support plate 122 in the first position of each bending plate 102. In some cases, “CT” may be a constant value based on the apparatus 100. In some other cases, “VD” may be a target vertical distance between the proximal end 136 of each bending plate 102 and the upper surface of the support plate 122 in the second position of each bending plate 102. In an example, “CT” may be about 1.25 inches (in) or 31.75 millimeters (mm). For GH=0, i.e., the proximal ends 136 touch each other in the first position, (OH=GA/2), and (VD=CT−GA/2).

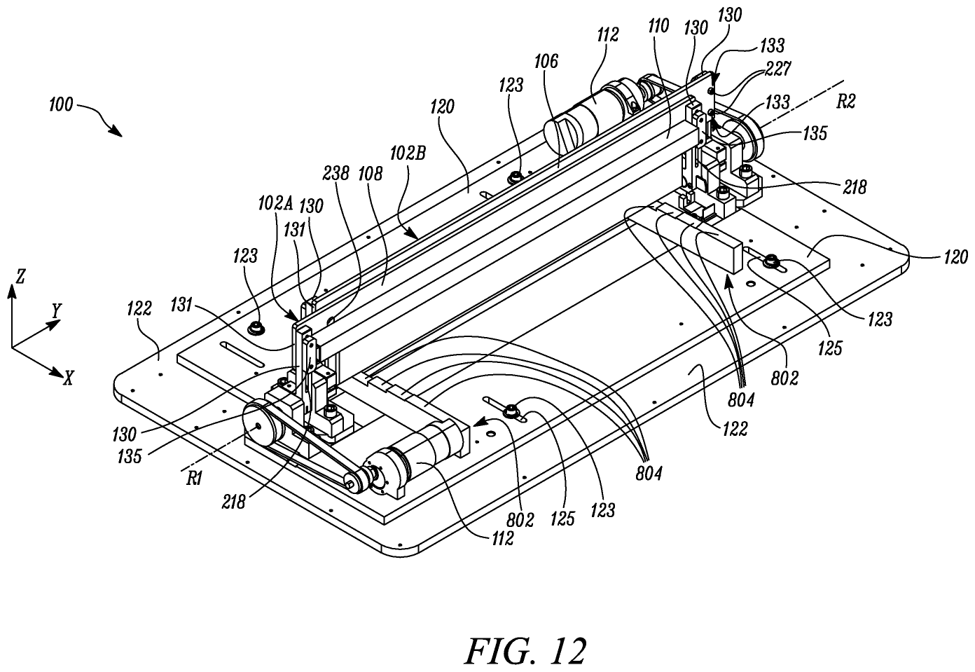

In some cases, a combination of one or more gauge blocks and one or more shims may be used to obtain a desired value of the vertical distance “VD”. FIG. 12 illustrates usage of a pair of gauge blocks 802.

Referring to FIGS. 11A, 11B and 12, the pair of gauge blocks 802 may be used for adjusting the vertical distance “VD”, the offset “OH” and/or the gap “GA”. Specifically, the gauge blocks 802 may be horizontal offset blocks for setting desired values of the vertical distance “VD”, the offset “OH” and/or the gap “GA” for a given value of the gap “GH”. In some embodiments, each gauge block 802 includes multiple block regions 804 separated by steps. In some cases, each block region 804 may correspond to a predetermined value of a block gap “GB”. For example, the gauge block 802 may include three block regions 804 with predetermined values of the block gap “GB” equal to about 20 mm, about 10 mm, about 4 mm and about 2 mm. In some cases, each predetermined value of the block gap “GB” may correspond to a value of the gap “GA” with (GH=0) while taking into account the constant “CT”. Further, each block region 804 of the gauge block 802 sets a value of the vertical distance “VD” with (GH=0) for the corresponding value of the block gap “GB”. In some cases, for GH=0, VD=1.25 in GB/2. In case the target value of the gap “GA” corresponds to any of the predetermined values of the block gap “GB” of the block regions 804 with the gap “GH” being zero, the gauge blocks 802 may be used for obtaining the target values of the gap “GA” and the offset “OH” without using any shims.

In some cases, each block region 804 may be provided with suitable indicia indicating the respective value of the block gap “GB”. Further, the gauge block 802 may be provided with other indicia indicating one or more relationships between various parameters.

Some exemplary scenarios for achieving a target value of the vertical distance “VD” are provided below:

If GH=0, GA=2, 4, 10 or 20 (i.e., the predetermined values for the block gap “GB”), then the gauge blocks 802 may be used for adjustment.

If GH=0, GA≠2,4,10 or 20 then the gauge blocks 802 along with one or more shims may be used for adjustment. If target is (OH=GA/2) (i.e., GH=0), then the block region 804 with a suitable value of the block gap “GB” may be chosen along with one or more shims, such that [GB/2−(shim thickness)=OH=GA/2].

If GH≠0, then the gauge blocks 802 and one or more shims may be used for adjustment. If target is (OH=(GA−GH)/2), then the block region 804 with a suitable value of the block gap “GB” is chosen along with one or more shims, such that [GB/2−(shim thickness)=OH=(GA−GH)/2].

The apparatus 100 may therefore have a dual hinge or pivot configuration as represented by the independent first and second rotational axes “R1”, “R2” of the first and second bending plates 102A, 102B, respectively. Due to the kinematics of the dual hinge or pivot configuration of the apparatus 100, any sample undergoing bending may not be mounted or taped on the bending plates 102 closer than OH=GA/2, otherwise it may induce additional strain in the sample.

Table 1,provided below, shows various examples of adjusting the vertical distance “VD”.

TABLE 1
Adjustment of Vertical Distance “VD”

| Targets | | | Tools Required | | |
|---|---|---|---|---|---|
| GA | GH | OH | GB | Shim | Vertical Distance (VD) |
| 10 mm | 0 | 5 mm | 10 mm | none | 1.053 in = 26.75 mm |
| | | | | | (1.25 in −5 mm) |
| 3 mm | 0 | 1.5 mm | 4 mm | 0.5 mm | 1.191 in = 30.25 mm (1.25 in −1.5 mm) $\underbrace{( 1.25 in - 2 mm )}_{Offset Block} + \underbrace{0.5 mm}_{shim}$ |
| 20 mm | 1 mm | 9.5 mm | 20 mm | 0.5 mm | 0.876 in = 22.25 mm (1.25 in −9.5 mm) $\underbrace{( 1.25 in - 10 mm )}_{Offset Block} + \underbrace{0.5 mm}_{shim}$ |
| 4 mm | 2 mm | 1 mm | 4 mm | 1 mm | 1.211 in = 30.75 mm (1.25 in −1 mm) $\underbrace{( 1.25 in - 2 mm )}_{Offset Block} + \underbrace{1 mm}_{shim}$ |

An exemplary adjustment of the offset “OH”, the gap “GA” and the vertical distance “VD” will be explained with reference to FIGS. 9, 12, 13, 14 and 15 with continued reference to FIGS. 1, 11A and 11B. The adjustment will be explained with a number of steps.

Step 1: The apparatus 100 may be actuated using the user interface 600 (shown in FIG. 9). Specifically, the first and second bending plates 102A, 102B may be actuated and stopped at the second or raised position by pressing the increment button 606. The first and second plates 102A, 102B may have to be generally perpendicular to the corresponding base plates 120. In some cases, an accurate right angle gauge may be used to verify and the first and second bending plates 102A, 102B may be pushed gently when the power is off.

Step 2: The operator or user may loosen the two arm fasteners 133 that couple the first bending plate 102A to the moving arm 130 that is driven by the respective electric motor 112. Similarly, the operator may loosen the two arm fasteners 133 that couple the second bending plate 102B to the moving arm 130 that is driven by the respective electric motor 112. The bolt heads 227 of the respective arm fasteners 133 may be exposed and therefore easily accessible due to the longitudinal offset “OP” (shown in FIG. 10) between the bending plates 102.

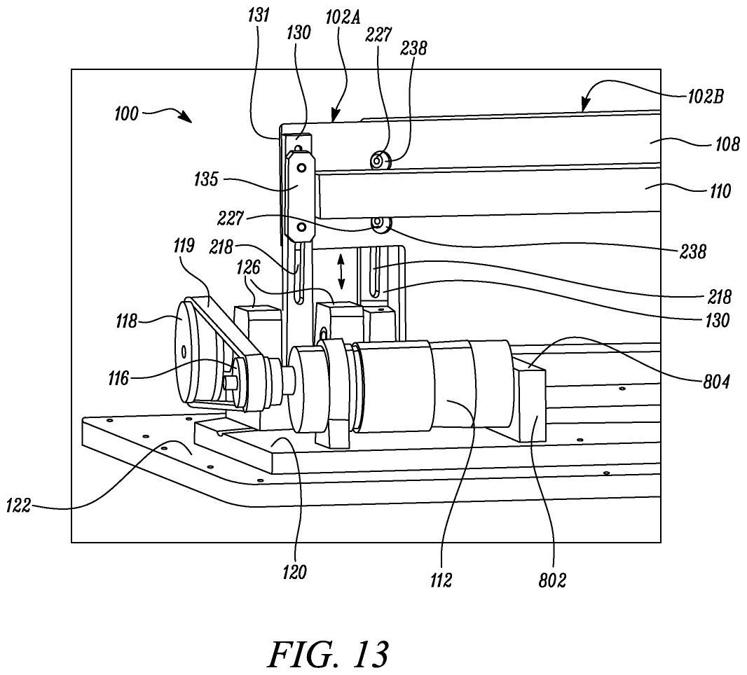

Step 3: The operator or user may loosen the two arm fasteners 133 that couple the first bending plate 102A to the moving arm 130 that is not driven by the respective electric motor 112. Similarly, the operator may loosen the two arm fasteners 133 that couple the second bending plate 102B to the moving arm 130 that is not driven by the respective electric motor 112. The bolt heads 227 of the respective arm fasteners 133 may be easily accessible through the respective access apertures 238 of the opposing bending plate 102A or 102B. In other words, as shown in FIG. 13, the operator may be able to access the bolt heads 227 of the respective arm fasteners 133 that couple the second bending plate 102B to the moving arm 130 that is not driven through the respective access apertures 238 of the first bending plate 102A. In the second or generally vertical position of each of the first and second bending plates 102A, 102B, the access apertures 238 may align with the bolt heads 227 of the respective arm fasteners 133 coupled to the second bending plate 102B. In the second position, the first and second bending plates 102A, 102B oppose each other. Similarly, the operator may be able to access the bolt heads 227 of the respective arm fasteners 133 that couple the first bending plate 102A to the moving arm 130 that is not driven through the respective access apertures 238 of the second bending plate 102B. In the second or generally vertical position of each of the first and second bending plates 102A, 102B, the access apertures 238 may align with the bolt heads 227 of the respective arm fasteners 133 coupled to the first bending plate 102A.

In the illustrated embodiment, each of the first and second bending apertures 102A, 102B includes two access apertures 238 for the two arm fasteners 133. In general, each of the first bending plate 102A and the second bending plate 102B further defines at least one access aperture 238 corresponding to a moving arm 130 from the pair of moving arms 130 coupled to the opposing bending plate 102A or 102B. The at least one access aperture 238 is configured to allow access to the head 227 of the at least one arm fastener 133 coupling the respective moving arm 130 to the opposing bending plate 102A or 102B. However, the first and second bending plates 102A, 102B may also be devoid of any access aperture 238 within the scope of the present disclosure.

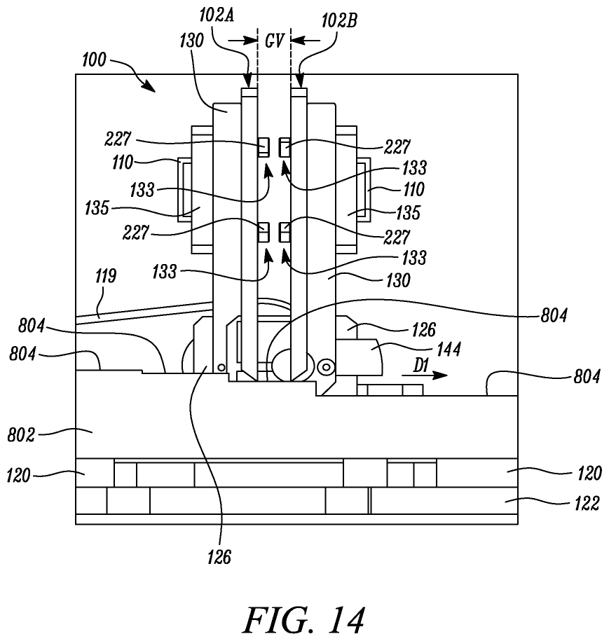

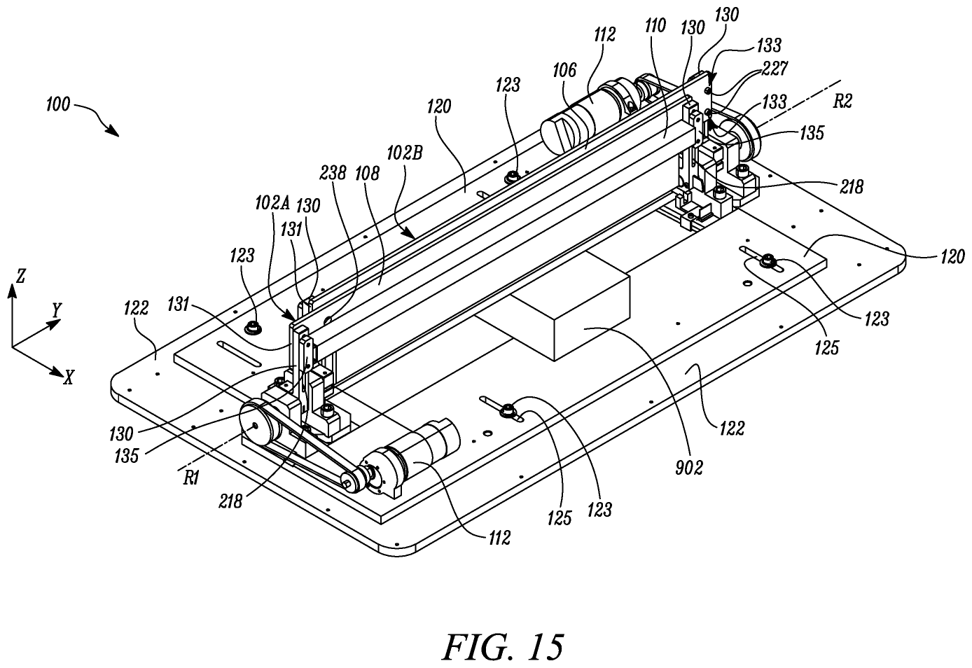

Step 4: The operator may set the pair of gauge blocks 802 across the two base plates 120. Two gauge blocks 802 may be used to substantially prevent any motion of the bending plates 102 during adjustment. However, in alternative embodiment, as illustrated in FIG. 15, a single gauge block 902 may be used for adjustment. In some cases, the operator may have to ensure that the first and second bending plates 102A, 102B are in contact with both the gauge blocks 802 and there is no debris present between the engaging surfaces of the bending plates 102 and the gauge blocks 802. For many desired thicknesses, one or more shims may be required in addition to the gauge blocks 802, as explained above with reference to FIGS. 11A and 11B and Table 1. For example, with reference to FIG. 14, the operator may place one of the block regions 804 below the bending plates 102. The block region 804 may have a desired value of the block gap “GB”. For example, the block region 804 placed below the bending plates 102 may have a value of 10 mm as the block gap “GB”. The target value of the gap “GA” may be 10 mm, the target value of the offset “OH” may be 5 mm, and the target value of the gap “GH” may be zero (i.e., no gap between the base plates 120). Based on Table 1, no shims may be required, and the adjustment may be carried out using the gauge blocks 802.

Step 5: The operator may then tighten the two pairs of arm fasteners 133 corresponding to each of the first and second bending plates 102A, 102B.

Step 6: The operator may then remove the gauge blocks 802.

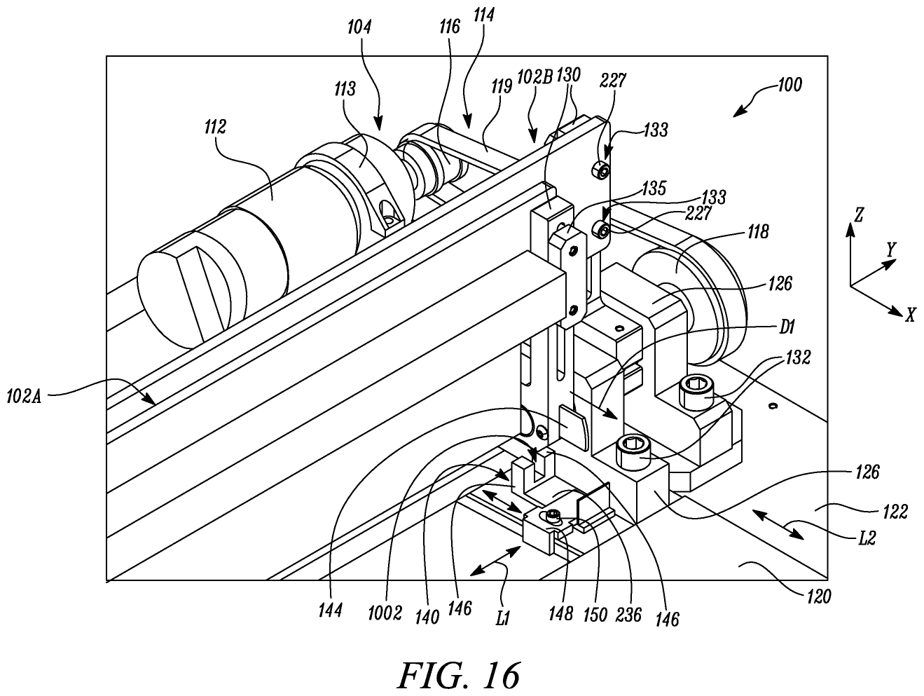

When the apparatus 100 is stopped in the down or generally horizontal position with respect to the bending plates 102, both of the first and second bending plates 102A, 102B may have to be generally horizontal and collinear. In other words, in the respective first positions, the first and second bending plates 102A, 102B may have to be generally horizontal or collinear. In some cases, there are two methods of adjusting the home position of each bending plate 102, namely, a coarse adjustment and a fine adjustment using software associated with the user interface 600. The home position or the first position of each of the first and second bending plates 102A, 102B may be independently adjustable. An exemplary procedure for adjusting the home or first position of the first bending plate 102A or the second bending plate 102B will be explained with reference to FIG. 16. Reference will also be made to FIGS. 1 and 9.

Course Adjustment: This procedure may be occasionally required in certain circumstances, for example, if the sensors 140 are replaced or dislodged.

Step 1: The operator may stop the apparatus 100 in the down position by pressing the decrement button 608 (shown in FIG. 9) while the apparatus 100 is running. The down position may correspond to the first or home position of each bending plate 102.

Step 2: The operator may test for collinearity by placing a flat reference across the two bending plates 102.

Step 3: The apparatus may move the bending plates 102 to the second or raised position in order to access the respective sensors 140.

Step 4: The operator may adjust the position of either the first bending plate 102A or the second bending plate 102B by loosening the clamping fastener 150 that clamps the sensor 140 in position via the clamping member 148. The operator may then slide the sensor 140 in a desired direction. The flag 144 that extends from the moving arm 130 may have to slide into a slot 1002 defined between the elongate portions 146 of the sensor 140. In some cases, the operator may set the bending plates 102 so that the bending plates 102 point slightly upwards (the bending plates 102 should not point below the horizontal or the X-axis), and then use a negative number in the software for fine adjustment.

Step 4: The adjustment may be tested by repeating Steps 1 and 2.

Fine Adjustment: A software offset value may adjust the home position from a trigger position of the sensor 140. There is a separate offset value for each of the electric motors 112. In some cases, the trigger position of the sensor 140 may correspond to the position where the flag 144 is disposed between the elongate portions 146, thereby triggering the sensor 140 to emit one or more signals. The sensor 140 may include suitable circuitry to detect the presence of the flag 144 in the slot 1002 between the elongate portions 146 and transmit signals.

Step 1: The operator may stop the apparatus 100 in the down position by pressing the decrement button 608 (shown in FIG. 9) while the apparatus 100 is running.

Step 2: The operator may test for collinearity by placing a flat reference across the two bending plates 102.

Step 3: The operator may adjust the position of either the first bending plate 102A or the second bending plate 102B by changing the values of the first home offset “H1” or the second home offset “H2” for an appropriate axis, for example, X, Y, or Z-axes. In some cases, the electric motor 112 corresponding to the second bending plate 102B may be located on the same side and adjacent to the circuit board 404 (shown in FIG. 7). In some cases, a negative value of the first home offset “H1” or the second home offset “H2” may move that bending plate 102 closer to the respective base plate 120.

Referring to FIG. 1, both of the belts 119 may not deflect more than 0.25 in when the belts 119 are pushed on the mid-span with a few pounds of force. Referring to FIG. 16, if the belts 119 are very loose or are seen to skip teeth, then the belts 119 may have to be tightened by loosening the motor fastener (not shown) that secures the respective electric motor 112 to the motor clamp 113, then rotating the electric motor 112 to tighten the belt 119, and then tightening the motor fastener again. The motor fastener may secure the split ends of the motor clamp 113 to each other.

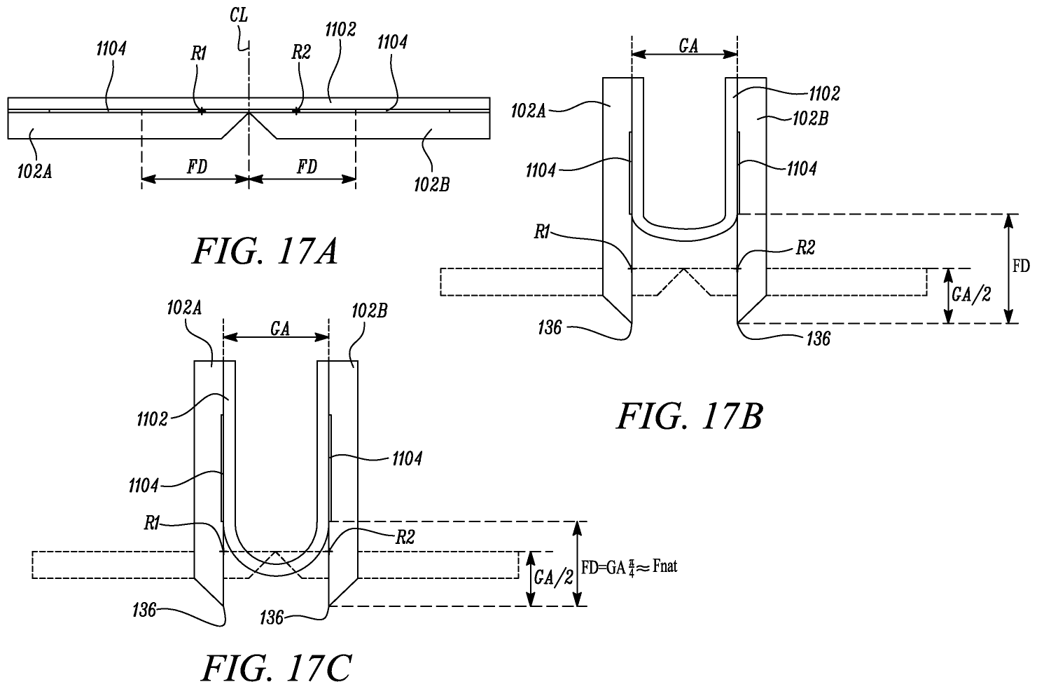

FIGS. 17A and 17B illustrate schematic views of the apparatus 100 with an object 1102 mounted on the first and second bending plates 102A, 102B. Various components of the apparatus 100 are not shown in FIGS. 17A and 17B for the purposes of illustration. FIG. 17A shows the first and second bending plates 102A, 102B in the first or generally horizontal position. FIG. 17B illustrates the first and second bending plates 102A, 102B in the second or generally vertical position. In some cases, the object 1102 may be a film sample. The object 1102 may undergo bending by the apparatus 100 for a number of cycles. In some cases, the object 1102 may be removably mounted on the first and second bending plates 102A, 102B via adhesives tapes 1104. In some cases, the gap “GA” between the first and second rotational axes “R1”, “R2” may correspond to a bend diameter of the object 1102. In order words, the gap “GA” may be substantially equal to the bend diameter. In the illustrated embodiment of FIGS. 17A and 17B, the gap “GH” is substantially zero, i.e., no gap is provided between the first and second bending plates 102A, 102B in the first or generally horizontal position. A distance between a center line “CL” and a start of attachment of the object 1102 in the horizontal plane (i.e., X-Y plane) is indicated by a fixed distance “FD”. The dual hinge or pivot configuration of the apparatus 100 and the manner of attachment of the object 1102 to the bending plates 102 may affect a strain that is applied on the object 1102 during bending. There may be three possible cases:

Case 1: FD<GA/2, The object 1102 may stretch or break due to strain.

Case 2: FD=GA/2, The object 1102 may form sharp right angles and may just fill the gap “GA”.

Case 3: FD>GA/2, An excess portion of the object 1102 may exist to fill the gap “GA”. Further, the object 1102 may not undergo any strain.

However, an amount of bending stress may exist in a free loop of the object 1102 between the attachment regions. The bending stress may decrease with an increase in the fixed distance “FD” beyond (GA/2) until the bending stress is substantially equal to a minimum value at “Fnat”. “Fnat” may be a threshold value of the fixed distance “FD”. Further, “Fnat” may correspond to a natural bend radius of a material being held between the bending plates 102. For FD>Fnat, there may be minimal change in behavior of the object 1102. “Fnat” may be close to FD=GA*(n/4) which is the distance for a natural semicircle, as shown in FIG. 17C. For most practical cases, the bending plates 102 may not need to exist beyond the pivot points or the rotational axes “R1”, “R2” since it may not be possible for the object 1102 to contact the bending plates 102 beyond the pivot points in the vertical or upright position (shown in FIG. 17B) and it is impractical to attach the object 1102 beyond the pivot points.

The dual pivot configuration of the apparatus 100, according to the present disclosure, may therefore reduce or substantially eliminate any bending stress on an object or a sample undergoing bending by the apparatus 100. Further, the dual pivot configuration of the present disclosure may substantially eliminate any strain of the sample during bending. This is in contrast to a conventional single pivot configuration (not shown) which only includes a single pivot point for bending a sample. The conventional single pivot configuration may include a plate that is stationary and another plate that pivots relative to the stationary plate. The sample is typically mounted on the stationary plate and the pivoting plate. In case of the conventional single pivot configuration, there is always a positive strain of the sample. Further, the sample is stretched and cannot interact with a gap that exists between the plates when the pivot plate has pivoted with respect to the stationary plate. In the conventional single pivot configuration, there is no fixed distance between the attachment points of the sample that can substantially eliminate strain. Instead, the strain decreases asymptotically with an increase in the fixed distance.

Further, various parameters of the apparatus 100 may be adjustable as per application requirements. In some embodiments, such parameters may include the gap “GA” between the rotational axes “R1”, “R2” or the bend diameter, the offset “OH” between the respective rotational axes “R1”, “R2” and the proximal ends 136 of the respective bending plates 102, the gap “GH” between the proximal ends 136 of the bending plates 102, the velocity or speed of each bending plate 102, the angular range of motion of each bending plate 102, the first and second delays at the respective first and second positions of each bending plate 102, the target count of the number of cycles, and so forth. The first and second bending plates 102A, 102B can be rotated independently of each other by controlling the respective electric motors 112. For example, the first and second bending plates 102A, 102B may be moved independently or simultaneously. In some cases, the PID control algorithm with the gravitational offset and the acceleration offset may be used to minimize overshoot and accurately follow a target motion profile of each bending plate 102.

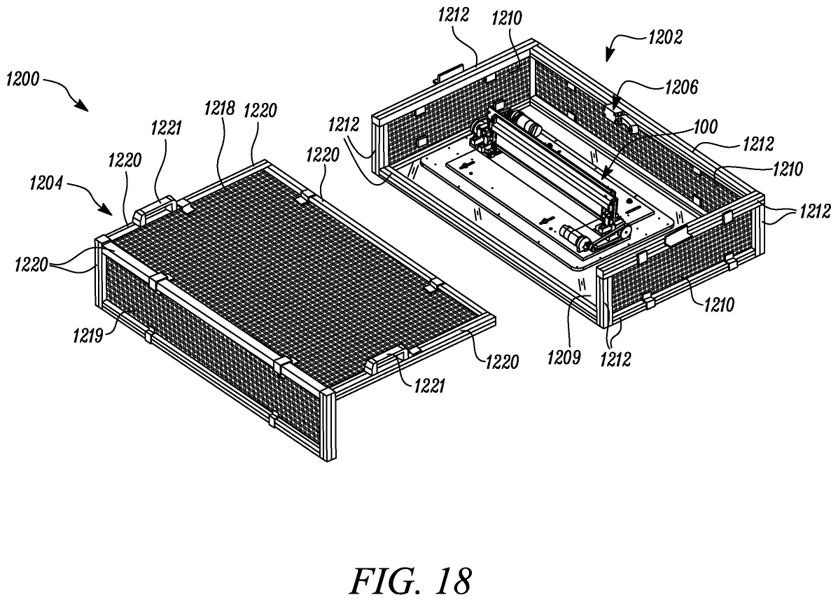

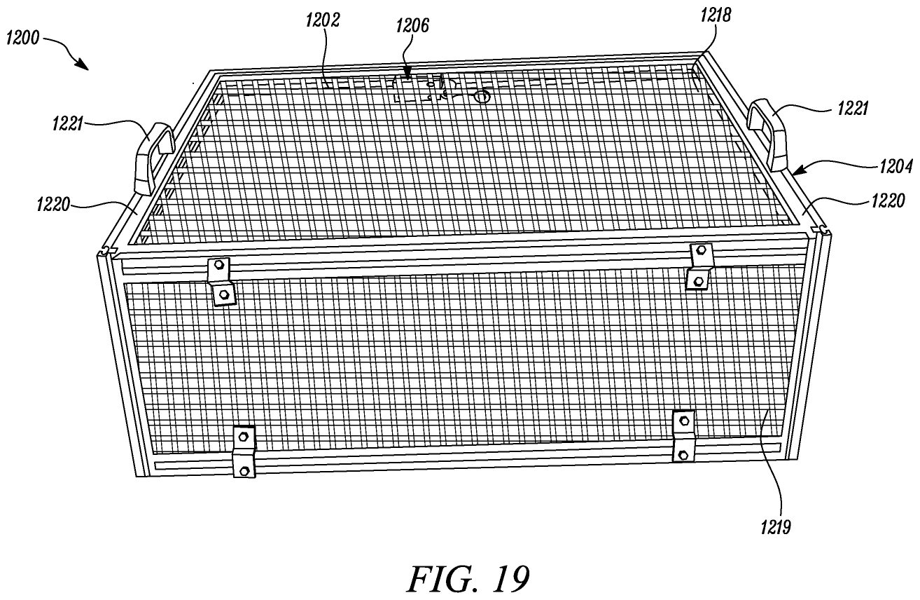

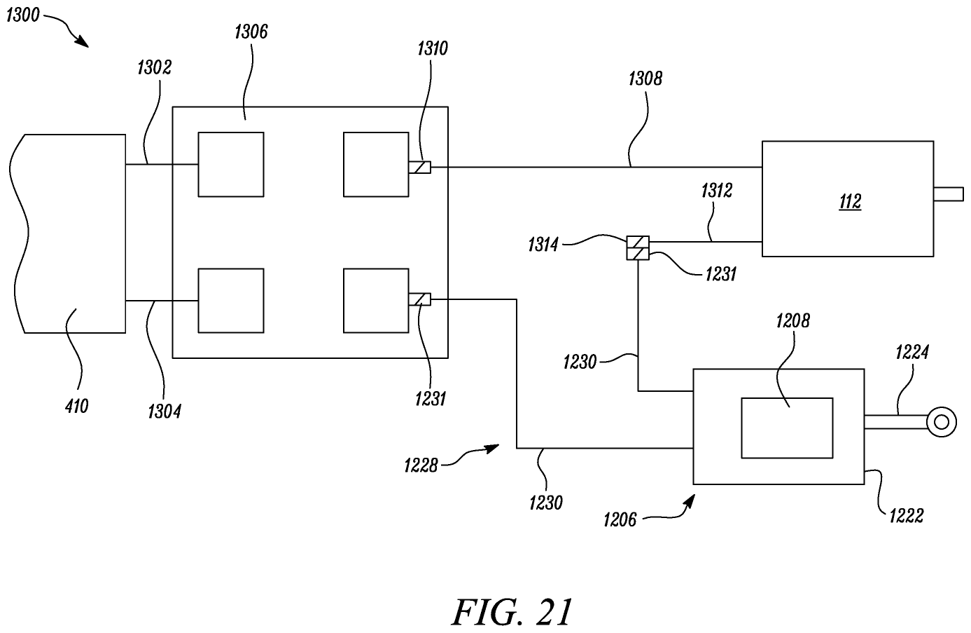

FIGS. 18 and 19 illustrate a perspective view of a safety cage 1200 for use with the apparatus 100. In some embodiments, the safety cage 1200 includes a main body 1202 for receiving the apparatus 100, a lid 1204 removably coupled to the main body 1202, and an interlock mechanism 1206 operably engaged with the lid 1204 and communicably coupled to the pair of rotation elements 104 (shown in FIG. 1). FIG. 19 omits certain components of the safety cage 1200 for the purpose of clarity. In some embodiments, the interlock mechanism 1206 includes an interlock circuit 1208 (shown in FIG. 21) that is configured to interrupt power supply to the pair of rotation elements 104 upon removal of the lid 1204 from the main body 1202 during a bending operation. In some other embodiments, the interlock circuit 1208 is further configured to restore power to the pair of rotation elements 104 upon replacement of the lid 1204 to the main body 1202. In some embodiments, the controller 138 (shown in FIG. 1) is further configured to store values related to the bending operation upon interruption of power supply to the pair of rotation elements 104. In other words, the interlock circuit 1208 may interrupt power supply to the pair of electric motors 112 of the rotation elements 104 upon removal of the lid 1204 from the main body 1202 during an operation. In some embodiments, the controller 138 may detect the interruption of power to the electric motors 112 and may store or record current experimental or operational values (e.g., cycle count) in the associated memory. In some cases, the controller 138 may further signal the error or the interruption in power to the user. In some cases, the lid 1204 may have to be replaced for the experiment or operation to continue. Since the experimental values are stored upon interruption, the experiment may continue from the interrupted state without any loss of data. In some cases, the main body 1202 of the safety cage 1200 may have a substantially cuboidal shape with an open upper surface and an open front surface without any mesh structure.

In some embodiments, the lower surface may include a bottom member 1209. In some cases, the bottom member 1209 may have a substantially rectangular shape. The lid 1204 may be disposed on the upper surface and the front surface of the main body 1202. In some cases, the main body 1202 may include multiple mesh structures 1210 supported by elongate members 1212. The mesh structures 1210 may be disposed on corresponding surfaces of the safety cage 1200 except the upper surface and the front surface. In some cases, the main body 1202 may be removably coupled to the lid 1204 by any attachment methods, such as latches, mechanical fasteners, and so forth. In some cases, the lid 1204 may include an upper mesh structure 1218 and a front mesh structure 1219 supported by elongate sections 1220. In some other cases, the lid 1204 may also include one or more handles 1221 to facilitate manual gripping of the lid 1204.

As shown in FIG. 18, the apparatus 100 may be placed inside the main body 1202 on the bottom member 1209. The lid 1204 may be placed on the main body 1202 and detachably coupled to the main body 1202. The assembled configuration of the safety cage 1200 is shown in FIG. 19 without the apparatus 100. The mesh structures 1210 of the main body 1202, and the upper mesh structure 1218 and the front mesh structure 1219 of the lid 1204 may provide safety from the various moving parts (e.g., the bending plates 102) and the electric motors 112 of the apparatus 100 during operation. The safety cage 1200 may enable the apparatus 100 to be used on a desk with users located nearby. Further, the mesh structures 1210 of the main body 1202, and the upper and front mesh structures 1218, 1219 of the lid 1204 may also allow observation of the apparatus 100 during operation.

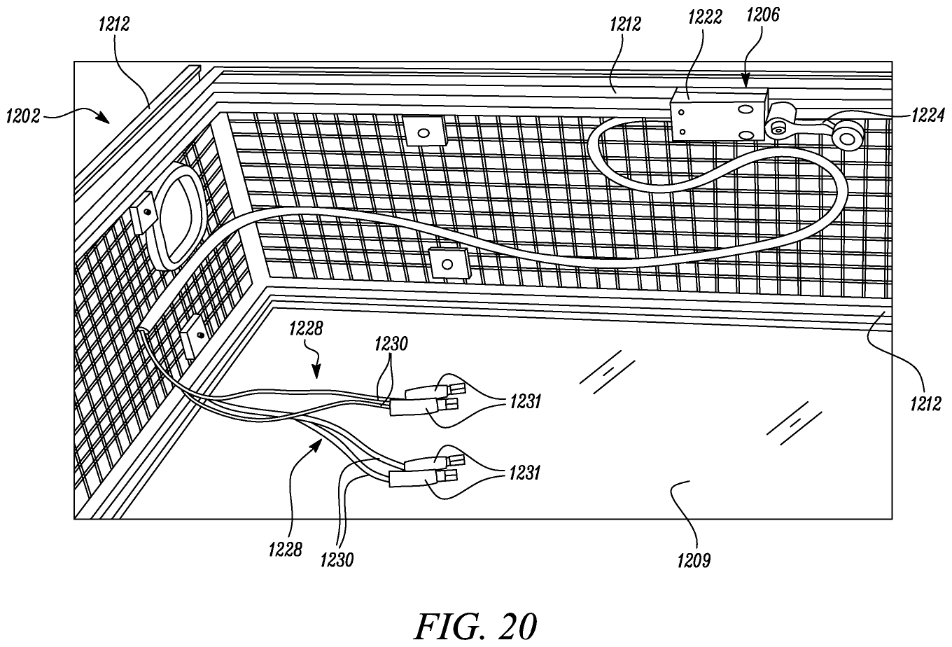

FIG. 20 illustrates a detailed view of the main body 1202 of the safety cage 1200. As shown in FIG. 20, the interlock mechanism 1206 is located on a rear surface of the main body 1202. In some cases, the interlock mechanism 1206 may be a NGCMB10AX24A1A limit switch from Honeywell. Referring to FIGS. 19-21, the interlock mechanism 1206 may include a body 1222 coupled to one of the elongate members 1212. The body 1222 may enclose the interlock circuit 1208 and a sensor. In some embodiments, the interlock mechanism 1206 may detect the removal of the lid 1204 from the main body 1202. In some cases, the interlock circuit 1208 may interrupt power to the electric motors 112 based on the actuation of an arm 1224 on the interlock mechanism 1206. In some cases, two sets 1228 of interlock cables 1230 may extend from the body 1222. The interlock cables 1230 may be electrically connected to the interlock circuit 1208. In some cases, each set 1228 may be color coded based on the set of control cables 410 (shown in FIG. 7). In some other cases, each set 1228 includes two interlock cables 1230. In some cases, each set 1228 may be used with one electric motor 112. The sets 1228 may be interchangeably used for interfacing with the respective electric motors 112. Each interlock cable 1230 may include a connector 1231 at an end. In some cases, each connector 1231 may be a Powerpole® connector manufactured by Anderson Power Products.

FIG. 21 illustrates a schematic view of an interlock control system 1300 associated the apparatus 100. Reference will also be made to FIGS. 7, 18-20. The interlock control system 1300 is illustrated for one of the electric motors 112. In some cases, interlock details for the other electric motor 112 may be substantially same. The set of control cables 410 from the controller box 402 (shown in FIG. 7) includes a first cable 1302 and a second cable 1304 for each electric motor 112. In some cases, the first and second cables 1302, 1304 may be color coded. For example, the first cable 1302 may be red (positive) and the second cable 1304 may be black (negative). The two sets 1228 of interlock cables 1230 are similarly color coded. For example, one set 1228 may be red and another set 1228 may be black. One of the sets 1228 is shown in FIG. 21 for interfacing with one electric motor 112. In the illustrated embodiment of FIG. 21, the first cable 1302 is connected to a breakout board 1306. In some cases, the breakout board 1306 may correspond to the circuit board 404 (shown in FIG. 7). A first lead cable 1308 of the electric motor 112 is connected to the breakout board 1306 and the electric motor 112. In some cases, the first lead cable 1308 may be connected to the breakout board 1306 via a connector 1310. The first lead cable 1308 may be electrically connected to the first cable 1302 via the breakout board 1306. The second cable 1304 may also connected to the breakout board 1306. One interlock cable 1230 from the set 1228 may be connected to the breakout board 1306 and the interlock mechanism 1206. Specifically, the interlock cable 1230 may be electrically connected to the interlock circuit 1208. In some cases, the interlock cable 1230 may be connected to the breakout board 1306 via the connector 1231. Further, the interlock cable 1230 may be electrically connected to the second cable 1304 via the breakout board 1306. In some cases, the interlock cable 1230 and the second cable 1304 may have the same color code (for example, black). In some cases, the other interlock cable 1230 of the set 1228 may be connected to a second lead cable 1312 via the connector 1231 and a corresponding connector 1314 of the second lead cable. The second lead cable 1312 and the interlock cable 1230 may electrically connect the interlock circuit 1208 to the electric motor 112. If the apparatus 100 is removed from the safety cage 1200, the first and second lead cables 1308, 1312 may be directly connected to the breakout board 1306 via the respective connectors 1310, 1314. In some cases, the connectors 1310, 1314 may be Powerpole® connectors manufactured by Anderson Power Products. The interlock cables 1230 shown in FIG. 21 may belong to one of the two sets 1228 shown in FIG. 20. In some cases, the interlock cable 1230 may be selected based on the color coding of the second cable 1304 that is interfaced with the interlock circuit 1208. The other set 1228 of interlock cables 1230 may be interfaced with the other electric motor 112.

In some cases, the interlock circuit 1208 may include one or more components to perform various operations. Such components may include one or more switches, chips, capacitors, inductors, circuit boards, and the like.

In some embodiments, the controller 138 (shown in FIG. 1) may be communicably coupled to the breakout board 1306. In some cases, the controller 138 may receive signals upon interruption of power to the electric motor 112 by the interlock circuit 1208 and store the current experimental values in the associated memory. The current experimental values may include a current cycle count, various parameters (such as, current positions) related to the bending plates 102, and so forth. In some cases, the set of instructions or software code implemented by the controller 138 may cause the controller 138 to store the current experimental values detecting interruption of power to the electric motors 112.

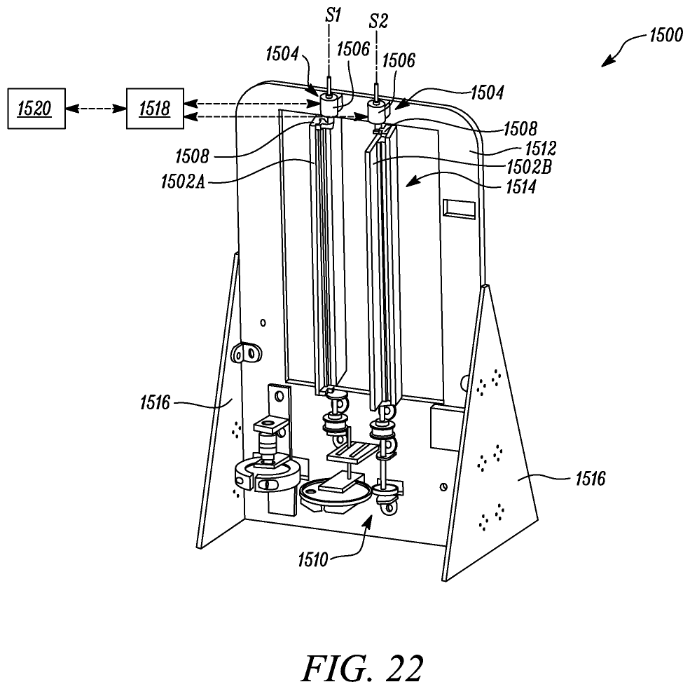

FIG. 22 illustrates an apparatus 1500 for bending an object according to another embodiment of the present disclosure. The apparatus 1500 includes a first bending plate 1502A having a first rotational axis “S1”, and a second bending plate 1502B having a second rotational axis “S2”, and a pair of rotation elements 1504. The second bending plate 1502B is disposed proximate to the first bending plate 1502A. The first and second bending plates 1502A, 1502B are rotatable about the first and second rotational axes “S1”, “S2”, respectively. Each rotation element 1504 controls a respective bending plate 1502A or 1502B from the first bending plate 1502A and the second bending plate 1502B. Each of the pair of rotation elements 1504 is operably coupled the respective bending plate 1502A or 1502B. The first and second bending plates 1502A, 1502B may be collectively referred to as the “bending plates 1502” or “the bending plate 1502”.

The first bending plate 1502A and the second bending plate 1502B are configured to rotate independently from each other about the first rotational axis “S1” and the second rotational axis “S2”, respectively. Each of the pair of rotation elements 1504 may control the rotation of the respective bending plate 1502A or 1502B about the respective rotational axis “S1” or “S2”. Each rotation element 1504 is configured to selectively rotate the respective bending plate 1502A or 1502B from the first bending plate 1502A and the second bending plate 1502B.

The first and second bending plates 1502A, 1502B support the object that undergoes bending. The object may be removably mounted on the first bending plate 1502A and the second bending plate 1502B. For example, the object may be mounted on a surface of the first bending plate 1502A and on a surface of the second bending plate 1502B by adhesive tapes.

Each of the rotation elements 1504 further includes an electric motor 1506 operably coupled to the respective bending plate 1502A or 1502B. In some embodiments, an output shaft of each electric motor 1506 may be connected to the respective bending plate 1502 via a connecting member 1508. Each electric motor 1506 is connected to the respective bending plate 1502 at one end. In some embodiments, each of the first and second bending plates 1502A, 1502B are further rotatably supported at another end via a base assembly 1510. In some cases, the base assembly 1510 may include various components, such as one or more shafts, bearings, and so forth.

The apparatus 1500 further includes a support member 1512 defining an opening 1514 therethrough. Each rotation element 1504 is mounted on the support member 1512 and operably coupled to the respective bending plate 1502. The first bending plate 1502A and the second bending plate 1502B are disposed in the opening 1514 of the support member 1512. In some embodiments, the electric motors 1506 and one or more components of the base assembly 1510 are mounted on the support member 1512. Further, the electric motors 1506 and the base assembly 1510 are disposed proximal to opposite ends of the opening 1514. In some cases, the opening 1514 may have a generally rectangular shape. In some embodiments, the support member 1512 is further supported on a surface by a pair of stands 1516.

In some embodiments, each of the first bending plate 1502A and the second bending plate 1502B is rotatable in an angular range of about 180 degrees. The opening 1514 may enable each of the first and second bending plates 1502A, 1502B to rotate about the first and second rotational axes “S1”, “S2”, respectively, in an angular range of about 180 degrees. In some cases, the angular range of motion of about 180 degrees may fold or bend the object mounted on the first and second bending plates 1502A, 1502B in a trifold or a Z-fold configuration.

In some embodiments, the apparatus 1500 further includes a controller 1518 communicably coupled to the pair of rotation elements 1504 including the electric motors 112. The controller 1518 is configured to control the pair of rotation elements 1504 to rotate the first bending plate 1502A and the second bending plate 1502B independently from each other about the first rotational axis “S1” and the second rotational axis “S2”, respectively. Each rotation element 1504 is configured to selectively rotate the respective bending plate 1502A or 1502B from the first bending plate 1502A and the second bending plate 1502B based upon control signals received from the controller 1518. In some embodiments, the controller 1518 may adjust or control various parameters of the apparatus 100 similar to the controller 138 (shown in FIG. 1) associated with the apparatus 100 described above. The controller 1518 may further receive user inputs for a user interface 1520.

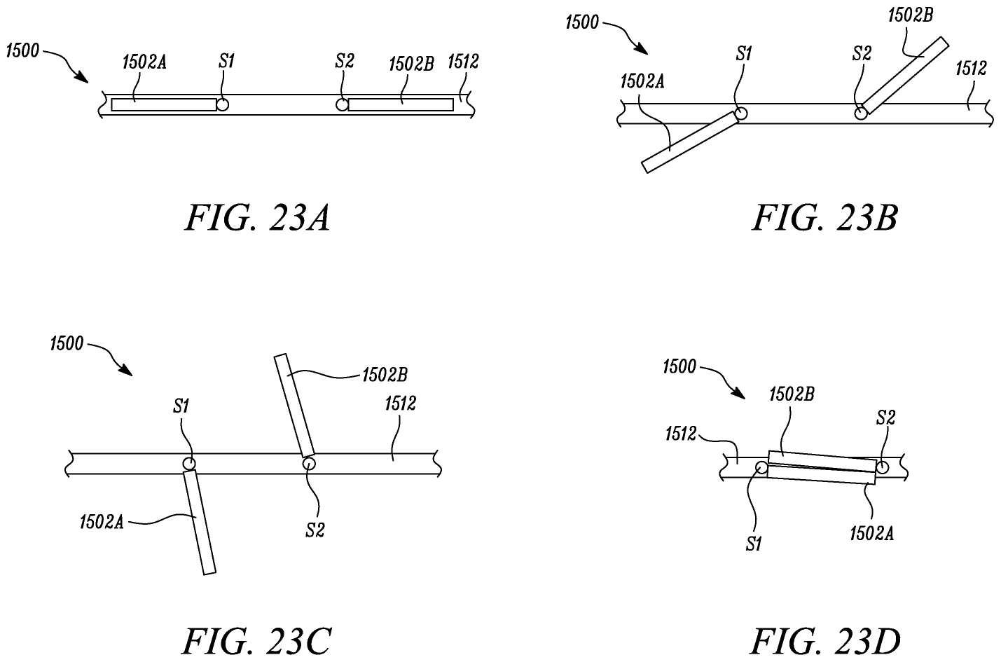

FIGS. 23A, 23B, 23C and 23D illustrate schematic views of the apparatus 1500. Some of the components of the apparatus 1500 have been omitted in FIGS. 23A-23D for the purpose of illustration. The support member 1512 is schematically shown also because it is the ground link for the motion of the bending plates 1502. Further, the first and second rotational axes “S1”, “S2” are also shown as pivot or hinge points. Each of the first and second bending plates 1502A, 1502B is rotatable about the respective rotational axis “S1” or “S2” between a respective first position and a respective second position relative to the support member 1512. In the first position, as shown in FIG. 23A, the first and second bending plates 1502A, 1502B are inclined at an angle of about 180 degrees with respect to each other. FIG. 23B shows an intermediate position where the first and second bending plates 1502A 1502B are substantially parallel to each other in an angular orientation with respect to the support member 1512. FIG. 23C shows another intermediate position where the first and second bending plates 1502A 1502B are substantially parallel to each other in another angular orientation with respect to the support member 1512. In the second position, as shown in FIG. 23D, each of the first and second bending plates 1502A 1502B face each other. Therefore, the angular range between the first and second positions of each of the first and second bending plates 1502A, 1502B is about 180 degrees.

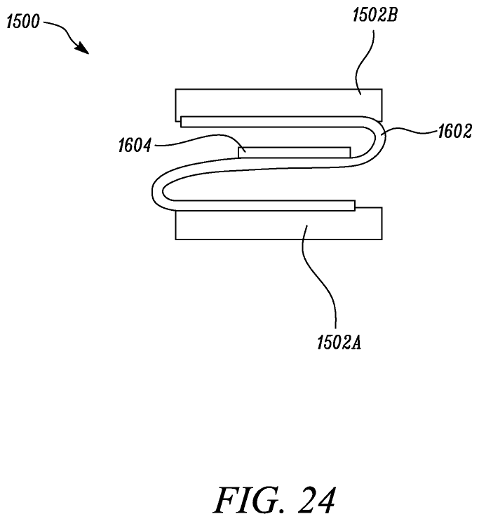

FIG. 24 illustrates a schematic view of an object 1602 (for example, a film sample) mounted on the first and second bending plates 1502A, 1502B. In the second position of each of the first and second bending plates 1502A, 1502B, as shown in FIG. 23, the object 1602 may be bent or folded in a trifold or a Z-fold configuration. In some cases, a middle portion of the object 1602 may be reinforced with a reinforcing member 1604 to control where bending occurs.

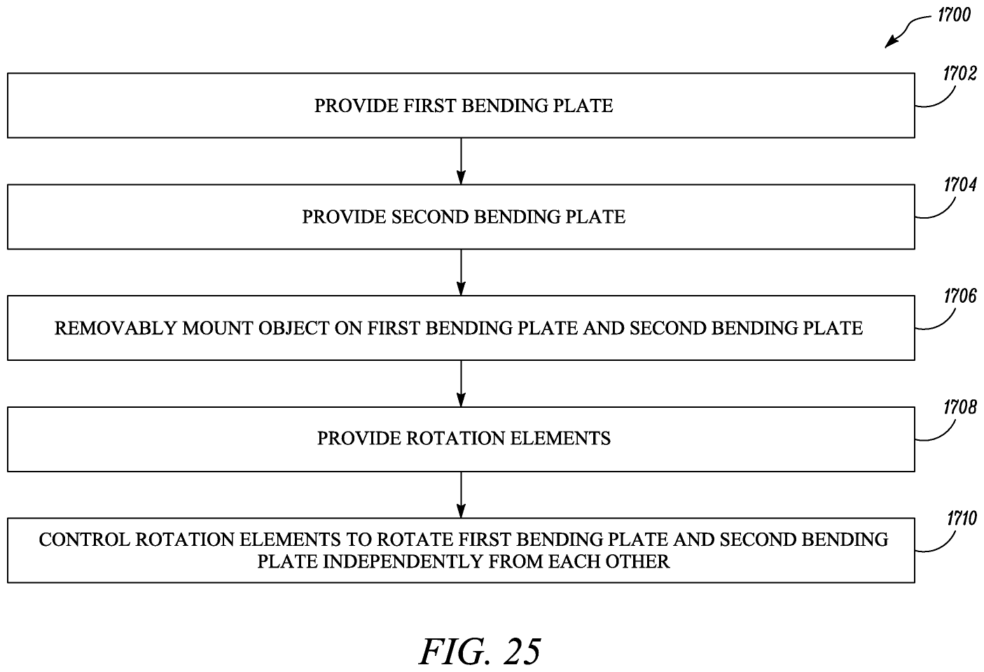

FIG. 25 illustrates a method 1700 of for bending an object. The method 1700 may be implemented by the apparatus 100 (shown in FIG. 1) or the apparatus 1500 (shown in FIG. 22). The method 1700 will be described with reference to the apparatus 100.

At step 1702, the method 1700 includes providing the first bending plate 102A having the first rotational axis “R1”. At step 1704, the method 1700 further includes providing the second bending plate 102B having the second rotational axis “R2”. The second bending plate 102B is disposed proximate to the first bending plate 102A. At step 1706, the method 1700 further includes removably mounting the object on the first bending plate 102A and the second bending plate 102B. Referring to FIG. 17A, the object 1102 may be removably mounted on the first and second bending plates 102A, 102B via the adhesive tapes 1104.

At step 1708, the method 1700 further includes providing the pair of rotation elements 104. Each rotation element 104 is configured to selectively rotate the respective bending plate 102A or 102B from the first bending plate 102A and the second bending plate 102B. Each rotation element 104 includes the electric motor 112 operably coupled to the respective bending plate 102. At step 1710, the method 1700 further includes controlling, via the controller 138, the pair of rotation elements 104 to rotate the first bending plate 102A and the second bending plate 102B independently from each other about the first rotational axis “R1” and the second rotational axis “R2” respectively.

In some embodiments, the method 1700 may further include adjusting the gap “GA” between the first rotational axis “R1” and the second rotational axis “R2”. The method 1700 may further include rotating each of the first bending plate 102A and the second bending plate 102B between the respective first position and the respective second position. In some embodiments, the method 1700 may further include adjusting at least one of the first position and the second position of each of the first bending plate 102A and the second bending plate 102B. In some embodiments, the method 1700 may further include adjusting the first delay at the first position of each of the first bending plate 102A and the second bending plate 102B. The method 1700 may further include adjusting the second delay at the second position of each of the first bending plate 102A and the second bending plate 102B. In some embodiments, the method 1700 may further include adjusting the offset “OH1” or “OH2” between the proximal end 136 of the respective bending plate 102A or 102B and the respective rotational axis “R1” or “R2” from the first rotational axis “R1” and the second rotational axis “R2”. In some other embodiments, the method 1700 may further include adjusting the angular speed of each of the first bending plate 102A and the second bending plate 102B. In some embodiments, the method 1700 further includes controlling the pair of rotation elements 104 to bend the object for a predetermined number of cycles. Each cycle includes a to-and-fro rotation of each of the first bending plate 102A and the second bending plate 102B between the first position and the second position.

In some embodiments, the method 1700 may further includes receiving, via the user interface 142, one or more user inputs indicative of values of one or more parameters, and controlling the rotation elements 104 based on the values of the one or more parameters. In some embodiments, the one or more parameters includes at least one of: the angular speed of each of the first bending plate 102A and the second bending plate 102B; the first position of each of the first bending plate 102A and the second bending plate 102B; the second position of each of the first bending plate 102A and the second bending plate 102B; the first delay at the first position of each of the first bending plate 102A and the second bending plate 102B; the second delay at the second position of each of the first bending plate 102A and the second bending plate 102B; the motion profile of each of the first bending plate 102A and the second bending plate 102B; and the number of cycles of bending. Each cycle includes a to-and-fro rotation of each of the first bending plate 102A and the second bending plate 102B between the first position and the second position.

In some embodiments, the method 1700 may further include receiving from the pair of sensors (the sensors 140 and/or the encoders 504) signals indicative of the angular positions of the respective bending plates 102A, 102B, and controlling the pair of the rotation elements 104 based on the angular positions of the respective bending plates 102A, 102B. In some cases, the method 1700 further includes controlling the pair of rotation elements 104 based on proportional-integral-derivative (PID) control. In some other cases, the method 1700 further includes controlling the pair of rotation elements 104 based on at least one of the gravity offset and the acceleration offset.

The following is a list of exemplary embodiments of the present disclosure.

Embodiment 1 is an apparatus for bending an object. The apparatus includes a first bending plate having a first rotational axis, and a second bending plate having a second rotational axis. The second bending plate is disposed proximate to the first bending plate. The apparatus further includes a pair of rotation elements. Each rotation element controls a respective bending plate from the first bending plate and the second bending plate. The first bending plate and the second bending plate are configured to rotate independently from each other about the first rotational axis and the second rotational axis, respectively.

Embodiment 2 is the apparatus of Embodiment 1 further including a support structure for rotatably supporting the first bending plate and the second bending plate. The support structure includes a pair of base plates. Each base plate is coupled to the respective bending plate such that the respective bending plate is rotatable relative to the base plate.

Embodiment 3 is the apparatus of any of the Embodiments 1-2, wherein the support structure further includes a support plate for supporting the pair of base plates thereon. At least one of the pair of base plates defines at least one base slot. The at least one base slot receives a base fastener therethrough for coupling the base plate to the support plate. In a loosened state of the base fastener, the base plate is movable along a length of the at least one base slot such that a gap between the pair of base plates is adjustable. The gap is disposed along a lateral axis of at least one of the pair of base plates.

Embodiment 4 is the apparatus of any of the Embodiments 1-3, wherein the respective bending plate is adjustably mounted on a respective base plate such that an offset between a proximal end of the respective bending plate and a respective rotational axis from the first rotational axis and the second rotational axis is adjustable.

Embodiment 5 is the apparatus of any of the Embodiments 1-4, further including a pair of bearing blocks coupled to each of the pair of base plates, a pair of shafts rotatably received through the respective bearing blocks, and a pair of moving arms coupled to respective shafts and rotatable about the respective rotational axis, each of the pair of moving arms further coupled to the respective bending plate. The pair of shafts are rotatable about a respective rotational axis from the first rotational axis and the second rotational axis. At least one of the pair of shafts is operably coupled to a respective rotation element from the pair of rotation elements.

Embodiment 6 is the apparatus of any of the Embodiments 1-5, wherein each of the pair of moving arms further defines an arm slot. The arm slot receives at least one arm fastener therethrough for coupling the moving arm to the respective bending plate. In a loosened state of the at least one arm fastener, the respective bending plate is movable along a length of the arm slot to adjust an offset between the respective rotational axis and a proximal end of the respective bending plate.

Embodiment 7 is the apparatus of any of the Embodiments 1-6, wherein each of the first bending plate and the second bending plate further defines at least one access aperture corresponding to a moving arm from the pair of moving arms coupled to an opposing bending plate. The at least one access aperture is configured to allow access to a head of the at least one arm fastener coupling the moving arm to the opposing bending plate.

Embodiment 8 is the apparatus of any of the Embodiments 1-7, further including a flag coupled to at least one of the pair of moving arms, and a sensor coupled to a respective base plate. The flag extends along a direction that is substantially perpendicular to the respective rotational axis. The sensor includes a pair of elongate portions spaced apart from each other. The flag is configured to be disposed between the elongate portions of the sensor in at least one position of the respective bending plate.

Embodiment 9 is the apparatus of any of the Embodiments 1-8, further including a clamping member configured to adjustably mount the sensor on the respective base plate. The clamping member is coupled to the respective base plate by a clamping fastener. In a loosened state of the clamping fastener, the sensor is slidable relative to the respective base plate to adjust at least one position of the respective bending plate.

Embodiment 10 is the apparatus of any of the Embodiments 1-9, further including a support member defining an opening therethrough. Each rotation element is mounted on the support member and operably coupled to the respective bending plate. The first bending plate and the second bending plate are disposed in the opening of the support member. Each of the first bending plate and the second bending plate is rotatable in an angular range of about 180 degrees.

Embodiment 11 is the apparatus of any of the Embodiments 1-10, further including a controller communicably coupled to the pair of rotation elements. The controller is configured to regulate one or more parameters. Each of the first bending plate and the second bending plate is rotatable between a respective first position and a respective second position. The one or more parameters includes at least one of: an angular speed of each of the first bending plate and the second bending plate; the first position of each of the first bending plate and the second bending plate; the second position of each of the first bending plate and the second bending plate; a first delay at the first position of each of the first bending plate and the second bending plate; a second delay at the second position of each of the first bending plate and the second bending plate; a motion profile of each of the first bending plate and the second bending plate; and a number of cycles of bending, each cycle including a to-and-fro rotation of each of the first bending plate and the second bending plate between the first position and the second position.

Embodiment 12 is a safety cage for use with the apparatus of any of the Embodiments 1-11, the safety cage including a main body for receiving the apparatus of any of the Embodiments 1-11 therein, a lid removably coupled to the main body, and an interlock mechanism operably engaged with the lid and communicably coupled to the pair of rotation elements. The interlock mechanism includes an interlock circuit that is configured to interrupt power supply to the pair of rotation elements upon removal of the lid from the main body during a bending operation. The interlock circuit is further configured to restore power to the pair of rotation elements upon replacement of the lid to the main body.

Embodiment 13 is a method for bending an object. The method includes providing a first bending plate having a first rotational axis, and providing a second bending plate having a second rotational axis. The second bending plate is disposed proximate to the first bending plate. The method further includes removably mounting the object on the first bending plate and the second bending plate. The method further includes providing a pair of rotation elements. Each rotation element is configured to selectively rotate a respective bending plate from the first bending plate and the second bending plate. The method further includes controlling, via a controller, the pair of rotation elements to rotate the first bending plate and the second bending plate independently from each other about the first rotational axis and the second rotational axis, respectively.

Embodiment 14 is the method of Embodiment 13, further including adjusting a gap between the first rotational axis and the second rotational axis, and adjusting an offset between a proximal end of the respective bending plate and a respective rotational axis from the first rotational axis and the second rotational axis.

Embodiment 15 is the method of any of the Embodiments 13-14, further including rotating each of the first bending plate and the second bending plate between a respective first position and a respective second position, receiving, via a user interface, one or more user inputs indicative of values of one or more parameters, and controlling the rotation elements based on the values of the one or more parameters. The one or more parameters includes at least one of: an angular speed of each of the first bending plate and the second bending plate; the first position of each of the first bending plate and the second bending plate; the second position of each of the first bending plate and the second bending plate; a first delay at the first position of each of the first bending plate and the second bending plate; a second delay at the second position of each of the first bending plate and the second bending plate; a motion profile of each of the first bending plate and the second bending plate; and a number of cycles of bending, each cycle including a to-and-fro rotation of each of the first bending plate and the second bending plate between the first position and the second position.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An apparatus for bending an object comprising:
a first bending plate having a first rotational axis;
a second bending plate having a second rotational axis, the second bending plate disposed proximate to the first bending plate; and
a pair of rotation elements, each rotation element controlling a respective bending plate from the first bending plate and the second bending plate;
wherein the first bending plate and the second bending plate are configured to rotate independently from each other about the first rotational axis and the second rotational axis, respectively.

2. The apparatus of claim 1, further comprising a support structure for rotatably supporting the first bending plate and the second bending plate, wherein the support structure comprises a pair of base plates, each base plate coupled to the respective bending plate such that the respective bending plate is rotatable relative to the base plate.

3. The apparatus of claim 2, wherein the support structure further comprises a support plate for supporting the pair of base plates thereon, wherein at least one of the pair of base plates defines at least one base slot, the at least one base slot receiving a base fastener therethrough for coupling the base plate to the support plate, wherein, in a loosened state of the base fastener, the base plate is movable along a length of the at least one base slot such that a gap between the pair of base plates is adjustable, the gap disposed along a lateral axis of at least one of the pair of base plates.

4. The apparatus of claim 2, wherein the respective bending plate is adjustably mounted on a respective base plate such that an offset between a proximal end of the respective bending plate and a respective rotational axis from the first rotational axis and the second rotational axis is adjustable.

5. The apparatus of claim 2, further comprising:
a pair of bearing blocks coupled to each of the pair of base plates;
a pair of shafts rotatably received through the respective bearing blocks, the pair of shafts rotatable about a respective rotational axis from the first rotational axis and the second rotational axis, wherein at least one of the pair of shafts is operably coupled to a respective rotation element from the pair of rotation elements; and
a pair of moving arms coupled to respective shafts and rotatable about the respective rotational axis, each of the pair of moving arms further coupled to the respective bending plate.

6. The apparatus of claim 5, wherein each of the pair of moving arms further defines an arm slot, the arm slot receiving at least one arm fastener therethrough for coupling the moving arm to the respective bending plate, wherein, in a loosened state of the at least one arm fastener, the respective bending plate is movable along a length of the arm slot to adjust an offset between the respective rotational axis and a proximal end of the respective bending plate.

7. The apparatus of claim 6, wherein each of the first bending plate and the second bending plate further defines at least one access aperture corresponding to a moving arm from the pair of moving arms coupled to an opposing bending plate, wherein, the at least one access aperture is configured to allow access to a head of the at least one arm fastener coupling the moving arm to the opposing bending plate.

8. The apparatus of claim 5, further comprising:
a flag coupled to at least one of the pair of moving arms, the flag extending along a direction that is substantially perpendicular to the respective rotational axis; and
a sensor coupled to a respective base plate, the sensor including a pair of elongate portions spaced apart from each other;
wherein the flag is configured to be disposed between the elongate portions of the sensor in at least one position of the respective bending plate.

9. The apparatus of claim 8, further comprising a clamping member configured to adjustably mount the sensor on the respective base plate, wherein the clamping member is coupled to the respective base plate by a clamping fastener, and wherein, in a loosened state of the clamping fastener, the sensor is slidable relative to the respective base plate to adjust at least one position of the respective bending plate.

10. The apparatus of claim 1, further comprising a support member defining an opening therethrough, each rotation element mounted on the support member and operably coupled to the respective bending plate, wherein the first bending plate and the second bending plate are disposed in the opening of the support member, and wherein each of the first bending plate and the second bending plate is rotatable in an angular range of about 180 degrees.

11. The apparatus of claim 1, further comprising a controller communicably coupled to the pair of rotation elements, the controller configured to regulate one or more parameters, wherein each of the first bending plate and the second bending plate is rotatable between a respective first position and a respective second position, the one or more parameters including at least one of:
an angular speed of each of the first bending plate and the second bending plate;
the first position of each of the first bending plate and the second bending plate;
the second position of each of the first bending plate and the second bending plate;
a first delay at the first position of each of the first bending plate and the second bending plate;
a second delay at the second position of each of the first bending plate and the second bending plate;
a motion profile of each of the first bending plate and the second bending plate; and
a number of cycles of bending, each cycle including a to-and-fro rotation of each of the first bending plate and the second bending plate between the first position and the second position.

12. A safety cage for use with the apparatus of claim 1, the safety cage comprising:
a main body for receiving the apparatus of claim 1 therein;
a lid removably coupled to the main body; and
an interlock mechanism operably engaged with the lid and communicably coupled to the pair of rotation elements, wherein the interlock mechanism comprises an interlock circuit that is configured to interrupt power supply to the pair of rotation elements upon removal of the lid from the main body during a bending operation, and wherein the interlock circuit is further configured to restore power to the pair of rotation elements upon replacement of the lid to the main body.

13. A method for bending an object, the method comprising:
providing a first bending plate having a first rotational axis;
providing a second bending plate having a second rotational axis, wherein the second bending plate is disposed proximate to the first bending plate;
removably mounting the object on the first bending plate and the second bending plate;
providing a pair of rotation elements, each rotation element configured to selectively rotate a respective bending plate from the first bending plate and the second bending plate; and
controlling, via a controller, the pair of rotation elements to rotate the first bending plate and the second bending plate independently from each other about the first rotational axis and the second rotational axis, respectively.

14. The method of claim 13, further comprising:
adjusting a gap between the first rotational axis and the second rotational axis; and
adjusting an offset between a proximal end of the respective bending plate and a respective rotational axis from the first rotational axis and the second rotational axis.

15. The method of claim 13, further comprising:
rotating each of the first bending plate and the second bending plate between a respective first position and a respective second position;
receiving, via a user interface, one or more user inputs indicative of values of one or more parameters; and
controlling the rotation elements based on the values of the one or more parameters;
wherein the one or more parameters includes at least one of:
an angular speed of each of the first bending plate and the second bending plate;
the first position of each of the first bending plate and the second bending plate;
the second position of each of the first bending plate and the second bending plate;
a first delay at the first position of each of the first bending plate and the second bending plate;
a second delay at the second position of each of the first bending plate and the second bending plate;
a motion profile of each of the first bending plate and the second bending plate; and
a number of cycles of bending, each cycle including a to-and-fro rotation of each of the first bending plate and the second bending plate between the first position and the second position.
